(19) United States
(12) Patent Application Publication
(10) Pub. No.: US 2015/0010068 A1
(43) Pub. Date: Jan. 8, 2015

(54) Method, device, and computer program for pre-encoding and post-decoding high bit-depth content in video encoder and decoder

(71) Applicant: CANON KABUSHIKI KAISHA, Tokyo (JP)

(72) Inventors: Edouard FRANCOIS, Bourg des Comptes (FR); Guillaume LAROCHE, Melesse (FR); Christophe GISQUET, Rennes (FR); Patrice ONNO, Rennes (FR)

(21) Appl. No.: 14/323,097

(22) Filed: Jul. 3, 2014

(30) Foreign Application Priority Data
Jul. 5, 2013 (GB) 1312140.5

(51) Int. Cl. H04N 19/85; H04N 19/44; H04N 19/126; H04N 19/25

(52) U.S. Cl. CPC H04N 19/00903; H04N 19/00406; H04N 19/00533; H04N 19/00096
USPC 375/240.08

(57) ABSTRACT

Pre-encoding a picture to be encoded by a coding process includes transformation and/or quantization, the picture including a plurality of samples of a predetermined bit-depth. After having split each of the samples of the picture into at least two sub-samples, each of the at least two sub-samples being of a predetermined bit-depth, the bit-depth of the samples being higher than the bit-depth of each of the at least two sub-samples, the at least two sub-samples of each of the samples are stored into at least two different components of at least one picture.

This application claims the benefit under 35 U.S.C. §119(a)-(d) of United Kingdom Patent Application No. 1312140.5, filed on Jul. 5, 2013 and entitled “Method, device, and computer program for pre-encoding and post-encoding high bit-depth content in video encoder and decoder”. The above cited patent application is incorporated herein by reference in its entirety.

### FIELD OF THE INVENTION

The invention generally relates to the field of video coding and decoding. More particularly, the invention concerns a method, device, and computer program for pre-encoding and post-decoding high bit-depth content in video encoder and decoder.

In embodiments of the invention the image is composed of blocks of pixels and is part of a digital video sequence. Embodiments of the invention relate to the field of video coding, in particular to video coding applicable to the High Efficiency Video Coding (HEVC) standard and to its extension for professional applications (HEVC Range Extensions, known as HEVC RExt).

### BACKGROUND OF THE INVENTION

Video data is typically composed of a series of still images which are shown rapidly in succession as a video sequence to give the idea of a moving image. Video applications are continuously moving towards higher and higher resolution. A large quantity of video material is distributed in digital form over broadcast channels, digital networks and packaged media, with a continuous evolution towards higher quality and resolution (e.g. higher number of pixels per frame, higher frame rate, higher bit-depth or extended color gamut). This technological evolution puts higher pressure on the distribution networks that are already facing difficulties in bringing HDTV resolution and high data rates economically to the end user.

Video coding is a way of transforming a series of video images into a compact bitstream so that the capacities required for transmitting and storing the video images can be reduced. Video coding techniques typically use spatial and temporal redundancies of images in order to generate data bit streams of reduced size compared with the original video sequences. Spatial prediction techniques (also referred to as Intra coding) exploit the mutual correlation between neighbouring image pixels, while temporal prediction techniques (also referred to as INTER coding) exploit the correlation between images of sequential images. Such compression techniques render the transmission and/or storage of the video sequences more effective since they reduce the capacity required of a transfer network, or storage device, to transmit or store the bit-stream code.

An original video sequence to be encoded or decoded generally comprises a succession of digital images which may be represented by one or more matrices the coefficients of which represent pixels. An encoding device is used to code the video images, with an associated decoding device being available to reconstruct the bit stream for display and viewing.

Common standardized approaches have been adopted for the format and method of the coding process. A video standard being standardized is HEVC, in which the macroblocks are replaced by what are referred to as Coding Units and are partitioned and adjusted according to the characteristics of the original image segment under consideration. This allows more detailed coding of areas of the video image which contain relatively more information and less coding effort for those areas with fewer features.

The video images may be processed by coding each smaller image portion individually, in a manner resembling the digital coding of still images or pictures. Different coding models provide prediction of an image portion in one frame, from a neighboring image portion of that frame, by association with a similar portion in a neighboring frame. This allows use of already available coded information, thereby reducing the amount of coding bit-rate needed overall. In general, the more information that can be compressed at a given visual quality, the better the performance in terms of compression efficiency.

It is known that to ensure good image rendering after encoding and decoding steps, it is important that bit-length of variables used to process images, encoded or not, is higher than the one of the image data, encoded or not, referred to as bit-depth, in particular because of rounding and clipping processes applied in transformation and quantization steps. It also turns out that when the bit-depth of the images is too high, there might be issues in the encoding and decoding processes regarding the precision of the internal operations. This may result in noticeable coding efficiency losses and in a saturation phenomenon of the reconstructed images quality, whatever the bitrate is. Accordingly, video encoders and decoders are to be adapted to the bit-depth content of the processed images. However, it can be desirable to re-use state-of-the-art video encoders and decoders, with few changes, for processing images having high bit-depth content, in particular for processing monochrome images having very high bit-depth content such as medical images.

The present invention has been devised to address one or more of the foregoing concerns.

### SUMMARY

Faced with these constraints, the inventors provide a method and a device for pre-encoding and post-decoding high bit-depth content in video encoder and decoder.

It is a broad object of the invention to remedy the shortcomings of the prior art as described above.

According to a first aspect of the invention there is provided a method of pre-encoding a picture to be encoded by a coding process comprising transformation and/or quantization, the picture comprising a plurality of samples of a predetermined bit-depth, the method comprising:

splitting each of the samples of the picture into at least two sub-samples, each of the at least two sub-samples being of a predetermined bit-depth, the bit-depth of the samples being higher than the bit-depth of each of the at least two sub-samples; and

storing the at least two sub-samples of each of the samples into at least two different components of at least one picture.

Such a method provides an efficient way of processing high bit-depth content in video encoders, for example encoders conforming to the HEVC standard. According to this embodiment, few changes are required in the current design of such encoders in order to re-use as far as possible the existing design, taking into account rounding and clipping processes applied in the transformation and quantization. The method is particularly adapted to process images having monochrome content with very high bit-depth. In other words, an advantage of the method is that it is possible to reuse an existing HEVC design adapted to handle 4:2:0, 4:2:2 or 4:4:4 chroma format to encode high bit-depth content that could not be processed normally by such an existing HEVC design.

In an embodiment, the at least two sub-samples of each of the samples are stored into two components of the same picture.

In an embodiment, the picture comprising the two components where the samples are stored conforms to the 4:4:4 YUV chroma format.

In an embodiment, the at least two sub-samples are stored into at least two intermediate sub-pictures which are arranged to form the at least two different components.

In an embodiment, the at least two sub-samples of each of the samples are stored into three components of the same picture.

In an embodiment, the at least two different components are color components of pictures.

In an embodiment, each of the at least two sub-samples of each of the samples are stored into a component of a picture, the at least two sub-samples of each of the samples being stored into different pictures.

In an embodiment, each of the different pictures comprises a single component.

In an embodiment, each of the at least two sub-samples of each of the samples are stored into three components of a picture, the at least two sub-samples of each of the samples being stored into different pictures.

In an embodiment, the bit-depth of a first sub-sample of each one of the samples is equal to the bit-depth of a second sub-sample of each one of the samples.

In an embodiment, the bit-depth of a first sub-sample of each one of the samples is different than the bit-depth of a second sub-sample of each one of the samples.

In an embodiment, a first picture of the different pictures is a main frame and a second picture of the different pictures, different than the first picture, is an auxiliary frame, a bit stream used to transmit the encoded picture comprising at least one item of information to indicate that the main frame is a main frame of a given picture and that the auxiliary frame is an auxiliary frame of the given picture.

In an embodiment, the at least one item of information is transmitted in a supplemental enhancement information message.

In an embodiment, splitting each of the samples of the picture into at least two sub-samples comprises extracting a set of most significant bits from each of the samples and extracting a complementary set of least significant bits from each of the samples, each of the set of most significant bits and of the set of least significant bits being used to form one of the at least two sub-samples.

In an embodiment, the bit-depth of a sub-sample comprising an extracted set of most significant bits is higher than or equal to the length of the extracted set.

In an embodiment, the bit-depth of a sub-sample comprising an extracted set of least significant bits is higher than or equal to the length of the extracted set.

In an embodiment, the method further comprises padding an empty bit of the sub-sample comprising the extracted set with a predetermined value.

In an embodiment, the set of most significant bits is stored into a first component of a picture, the set of least significant bits is stored into a second component of the same picture, and the coding process comprises quantization performed as a function of at least one quantization parameter, a first quantization parameter being applied to the first component and a second quantization parameter being applied to the second component, first quantization parameter being higher than the second quantization parameter.

In an embodiment, the second quantization parameter is equal to the first quantization parameter plus six times the length of the set of least significant bits.

In an embodiment, the set of most significant bits is stored into a first component of a picture, the set of least significant bits is stored into a second component of the same picture, and the coding process comprises a quantization performed as a function of at least one quantization parameter, the at least one quantization parameter being computed as a function of an item of data transmitted in a bit stream used to transmit the encoded picture.

In an embodiment, the set of most significant bits is stored into a first component of a picture, the set of least significant bits is stored into a second component of the same picture, and the coding process comprises a quantization, the quantization to be applied to the most significant bit set being performed as a function of the most significant bit set value.

In an embodiment, loop filter processes of the coding process are disabled.

In an embodiment, the coding process comprises loop filter processes that apply only to the most significant bit set.

In an embodiment, the coding process comprises loop filter processes that apply to the least significant bit set and to the most significant bit set, a quantization parameter to be used for processing the least significant bit set being set equal to a quantization parameter to be used for processing the most significant bit set plus a predetermined value.

In an embodiment, the encoded format conforms to the HEVC standard.

In an embodiment, the encoded format conforms to the HEVC RExt standard.

According to a second aspect of the invention there is provided a method of post-decoding a picture comprising a plurality of samples of a predetermined bit-depth, the picture being decoded by a decoding process comprising inverse transformation and/or inverse quantization, the decoding process providing a set of at least one picture comprising a plurality of components, at least two sub-samples of each of the samples being stored into different components of at least one picture, each of the at least two sub-samples being of a predetermined bit-depth, the bit-depth of the samples being higher than the bit-depth of each of the at least two sub-samples, the method comprising:

extracting from at least two different components of the at least one picture at least two sub-samples for each of the samples; and

merging the at least two extracted sub-samples, for each of the samples, to reconstruct the picture.

Such a method provides an efficient way of processing high bit-depth content in video decoders, for example decoders conforming to the HEVC standard. According to this embodiment, few changes are required in the current design of such decoders in order to re-use as far as possible the existing design, taking into account rounding and clipping processes applied in the transformation and quantization. The method is particularly adapted to process images having monochrome content with very high bit-depth. In other words, an advantage of the method is that it is possible to reuse an existing HEVC design adapted to handle 4:2:0, 4:2:2 or 4:4:4 chroma format to encode high bit-depth content that could not be processed normally by such an existing HEVC design.

In an embodiment, the at least two sub-samples of each of the samples are stored into two components of the same picture.

In an embodiment, the picture conforms to the 4:4:4 YUV chroma format.

In an embodiment, the at least two sub-samples are extracted from at least two intermediate sub-pictures resulting from the arrangement of the at least two different components.

In an embodiment, the at least two sub-samples of each of the samples are stored into three components of the same picture.

In an embodiment, the different components are color components of pictures.

In an embodiment, each of the at least two sub-samples of each of the samples are stored into a component of a picture, the at least two sub-samples of each of the samples being stored into different pictures.

In an embodiment, each of the different pictures comprises a single component.

In an embodiment, each of the at least two sub-samples of each of the samples are stored into three components of a picture, the at least two sub-samples of each of the samples being stored into different pictures.

In an embodiment, the bit-depth of a first sub-sample of each one of the samples is equal to the bit-depth of a second sub-sample of each one of the samples.

In an embodiment, the bit-depth of a first sub-sample of each one of the samples is different than the bit-depth of a second sub-sample of each one of the samples.

In an embodiment, a first picture of the different pictures is a main frame and a second picture of the different pictures, different than the first picture, is an auxiliary frame, a bit stream used to receive the picture to be decoded comprising at least one item of information to indicate that the main frame is a main frame of the picture and that the auxiliary frame is an auxiliary frame of the picture.

In an embodiment, the at least one item of information is received in a supplemental enhancement information message.

In an embodiment, merging the at least two extracted sub-samples comprises obtaining a first set of bits from one of the at least two extracted sub-samples and obtaining a second set of bits from another one of the at least two extracted sub-samples, the first set of bits forming a set of most significant bits and the second set of bits forming a set of least significant bits, the sets of most significant bits and of least significant bits being used to form one sample.

In an embodiment, the bit-depth of the sub-sample from which is obtained the first set of bits is higher than or equal to the length of the obtained set.

In an embodiment, the bit-depth of the sub-sample from which is obtained the second set of bits is higher than or equal to the length of the obtained set.

In an embodiment, the first set of bits is stored into a first component of a picture, the second set of bits is stored into a second component of the same picture, and the decoding process comprises an inverse quantization performed as a function of at least one quantization parameter, an inverse quantization based on a first quantization parameter being applied to the first component and an inverse quantization based on a second quantization parameter being applied to the second component, first quantization parameter being higher than the second quantization parameter.

In an embodiment, the second quantization parameter is equal to the first quantization parameter plus six times the length of the second set of bits.

In an embodiment, the first set of bits is stored into a first component of a picture, the second set of bits is stored into a second component of the same picture, and the decoding process comprises an inverse quantization performed as a function of at least one quantization parameter, the at least one quantization parameter being computed as a function of an item of data received in a bit stream used to receive the picture to be decoded.

In an embodiment, the first set of bits is stored into a first component of a picture, the second set of bits is stored into a second component of the same picture, and the decoding process comprises an inverse quantization, the inverse quantization to be applied to the first set of bits being performed as a function of the value of the first set of bits.

In an embodiment, loop filter processes of the decoding process are disabled.

In an embodiment, the decoding process comprises loop filter processes that apply only to the first set of bits.

In an embodiment, the decoding process comprises loop filter processes that apply to the second set of bits and to the first set of bits, a quantization parameter to be used for processing the second set of bits being set equal to a quantization parameter to be used for processing the first of bits set plus a predetermined value.

In an embodiment, the encoded format conforms to the HEVC standard.

In an embodiment, the encoded format conforms to the HEVC RExt standard.

According to a third aspect of the invention there is provided a device for pre-encoding a picture to be encoded by a coding process comprising transformation and/or quantization, the picture comprising a plurality of samples of a predetermined bit-depth, the device comprising at least one microprocessor configured for carrying out:

splitting each of the samples of the picture into at least two sub-samples, each of the at least two sub-samples being of a predetermined bit-depth, the bit-depth of the samples being higher than the bit-depth of each of the at least two sub-samples; and

storing the at least two sub-samples of each of the samples into at least two different components of at least one picture.

Such a device provides an efficient way of processing high bit-depth content in video encoders, for example encoders conforming to the HEVC standard. According to this embodiment, few changes are required in the current design of such encoders in order to re-use as far as possible the existing design, taking into account rounding and clipping processes applied in the transformation and quantization. The device is particularly adapted to process images having monochrome content with very high bit-depth. In other words, an advantage of the device is that it is possible to reuse an existing HEVC design adapted to handle 4:2:0, 4:2:2 or 4:4:4 chroma format to encode high bit-depth content that could not be processed normally by such an existing HEVC design.

In an embodiment, the microprocessor is further configured so that the at least two sub-samples of each of the samples are stored into two components of the same picture.

In an embodiment, the microprocessor is further configured so that the picture comprising the two components where the samples are stored conforms to the 4:4:4 YUV chroma format.

In an embodiment, the microprocessor is further configured so that the at least two sub-samples are stored into at least two intermediate sub-pictures which are arranged to form the at least two different components.

In an embodiment, the microprocessor is further configured so that the at least two sub-samples of each of the samples are stored into three components of the same picture.

In an embodiment, the at least two different components are color components of pictures.

In an embodiment, the microprocessor is further configured so that each of the at least two sub-samples of each of the samples are stored into a component of a picture, the at least two sub-samples of each of the samples being stored into different pictures.

In an embodiment, the microprocessor is further configured so that each of the different pictures comprises a single component.

In an embodiment, the microprocessor is further configured so that each of the at least two sub-samples of each of the samples are stored into three components of a picture, the at least two sub-samples of each of the samples being stored into different pictures.

In an embodiment, the bit-depth of a first sub-sample of each one of the samples is equal to the bit-depth of a second sub-sample of each one of the samples.

In an embodiment, the bit-depth of a first sub-sample of each one of the samples is different than the bit-depth of a second sub-sample of each one of the samples.

In an embodiment, a first picture of the different pictures is a main frame and a second picture of the different pictures, different than the first picture, is an auxiliary frame, a bit stream used to transmit the encoded picture comprising at least one item of information to indicate that the main frame is a main frame of a given picture and that the auxiliary frame is an auxiliary frame of the given picture.

In an embodiment, the microprocessor is further configured so that the at least one item of information is transmitted in a supplemental enhancement information message.

In an embodiment, the microprocessor is further configured so that splitting each of the samples of the picture into at least two sub-samples comprises extracting a set of most significant bits from each of the samples and extracting a complementary set of least significant bits from each of the samples, each of the set of most significant bits and of the set of least significant bits being used to form one of the at least two sub-samples.

In an embodiment, the bit-depth of a sub-sample comprising an extracted set of most significant bits is higher than or equal to the length of the extracted set.

In an embodiment, the bit-depth of a sub-sample comprising an extracted set of least significant bits is higher than or equal to the length of the extracted set.

In an embodiment, the microprocessor is further configured for carrying out padding an empty bit of the sub-sample comprising the extracted set with a predetermined value.

In an embodiment, the microprocessor is further configured so that the set of most significant bits is stored into a first component of a picture, the set of least significant bits is stored into a second component of the same picture, and the coding process comprises a quantization performed as a function of at least one quantization parameter, a first quantization parameter being applied to the first component and a second quantization parameter being applied to the second component, first quantization parameter being higher than the second quantization parameter.

In an embodiment, the second quantization parameter is equal to the first quantization parameter plus six times the length of the set of least significant bits.

In an embodiment, the microprocessor is further configured so that the set of most significant bits is stored into a first component of a picture, the set of least significant bits is stored into a second component of the same picture, and the coding process comprises a quantization performed as a function of at least one quantization parameter, the at least one quantization parameter being computed as a function of an item of data transmitted in a bit stream used to transmit the encoded picture.

In an embodiment, the microprocessor is further configured so that the set of most significant bits is stored into a first component of a picture, the set of least significant bits is stored into a second component of the same picture, and the coding process comprises a quantization, the quantization to be applied to the most significant bit set being performed as a function of the most significant bit set value.

In an embodiment, the microprocessor is further configured so that loop filter processes of the coding process are disabled.

In an embodiment, the microprocessor is further configured so that the coding process comprises loop filter processes that apply only to the most significant bit set.

In an embodiment, the microprocessor is further configured so that the coding process comprises loop filter processes that apply to the least significant bit set and to the most significant bit set, a quantization parameter to be used for processing the least significant bit set being set equal to a quantization parameter to be used for processing the most significant bit set plus a predetermined value.

In an embodiment, the encoded format conforms to the HEVC standard.

In an embodiment, the encoded format conforms to the HEVC RExt standard.

According to a fourth aspect of the invention there is provided a video encoder comprising the device as described above.

According to a fifth aspect of the invention there is provided a device for post-decoding a picture comprising a plurality of samples of a predetermined bit-depth, the picture being decoded by a decoding process comprising inverse transformation and/or inverse quantization, the decoding process providing a set of at least one picture comprising a plurality of components, at least two sub-samples of each of the samples being stored into different components of at least one picture, each of the at least two sub-samples being of a predetermined bit-depth, the bit-depth of the samples being higher than the bit-depth of each of the at least two sub-samples, the device comprising at least one microprocessor configured for carrying out:

extracting from at least two different components of at least one picture at least two sub-samples for each of the samples; and

merging the at least two extracted sub-samples, for each of the samples, to reconstruct the picture.

Such a device provides an efficient way of processing high bit-depth content in video decoders, for example decoders conforming to the HEVC standard. According to this embodiment, few changes are required in the current design of such decoders in order to re-use as far as possible the existing design, taking into account rounding and clipping processes applied in the transformation and quantization. The device is particularly adapted to process images having monochrome content with very high bit-depth. In other words, an advantage of the device is that it is possible to reuse an existing HEVC design adapted to handle 4:2:0, 4:2:2 or 4:4:4 chroma format to decode high bit-depth content that could not be processed normally by such an existing HEVC design.

In an embodiment, the at least two sub-samples of each of the samples are stored into two components of the same picture.

In an embodiment, the picture conforms to the 4:4:4 YUV chroma format.

In an embodiment, the microprocessor is further configured so that the at least two sub-samples are stored into two intermediate sub-pictures which are arranged to form the at least two different components.

In an embodiment, the microprocessor is further configured so that the at least two sub-samples of each of the samples are stored into three components of the same picture.

In an embodiment, the different components are color components of pictures.

In an embodiment, the microprocessor is further configured so that each of the at least two sub-samples of each of the samples are stored into a component of a picture, the at least two sub-samples of each of the samples being stored into different pictures.

In an embodiment, the microprocessor is further configured so that each of the different pictures comprises a single component.

In an embodiment, the microprocessor is further configured so that each of the at least two sub-samples of each of the samples are stored into three components of a picture, the at least two sub-samples of each of the samples being stored into different pictures.

In an embodiment, the bit-depth of a first sub-sample of each one of the samples is equal to the bit-depth of a second sub-sample of each one of the samples.

In an embodiment, the bit-depth of a first sub-sample of each one of the samples is different than the bit-depth of a second sub-sample of each one of the samples.

In an embodiment, a first picture of the different pictures is a main frame and a second picture of the different pictures, different than the first picture, is an auxiliary frame, a bit stream used to receive the picture to be decoded comprising at least one item of information to indicate that the main frame is a main frame of the picture and that the auxiliary frame is an auxiliary frame of the picture.

In an embodiment, the microprocessor is further configured so that the at least one item of information is received in a supplemental enhancement information message.

In an embodiment, the microprocessor is further configured so that merging the at least two extracted sub-samples comprises obtaining a first set of bits from one of the at least two extracted sub-samples and obtaining a second set of bits from another one of the at least two extracted sub-samples, the first set of bits forming a set of most significant bits and the second set of bits forming a set of least significant bits, the sets of most significant bits and of least significant bits being used to form one sample.

In an embodiment, the bit-depth of the sub-sample from which is obtained the first set of bits is higher than or equal to the length of the obtained set.

In an embodiment, the bit-depth of the sub-sample from which is obtained the second set of bits is higher than or equal to the length of the obtained set.

In an embodiment, the microprocessor is further configured so that the first set of bits is stored into a first component of a picture, the second set of bits is stored into a second component of the same picture, and the microprocessor is further configured so that the decoding process comprises an inverse quantization performed as a function of at least one quantization parameter, an inverse quantization based on a first quantization parameter being applied to the first component and an inverse quantization based on a second quantization parameter being applied to the second component, the first quantization parameter being higher than the second quantization parameter.

In an embodiment, the microprocessor is further configured so that the second quantization parameter is equal to the first quantization parameter plus six times the length of the second set of bits.

In an embodiment, the microprocessor is further configured so that the first set of bits is stored into a first component of a picture, the second set of bits is stored into a second component of the same picture, and the microprocessor is further configured so that the decoding process comprises an inverse quantization performed as a function of at least one quantization parameter, the at least one quantization parameter being computed as a function of an item of data received in a bit stream used to receive the picture to be decoded.

In an embodiment, the microprocessor is further configured so that the first set of bits is stored into a first component of a picture, the second set of bits is stored into a second component of the same picture, and the microprocessor is further configured so that the decoding process comprises an inverse quantization, the inverse quantization to be applied to the first set of bits being performed as a function of the value of the first set of bits.

In an embodiment, the microprocessor is further configured so that loop filter processes of the decoding process are disabled.

In an embodiment, the microprocessor is further configured so that the decoding process comprises loop filter processes that apply only to the first set of bits.

In an embodiment, the microprocessor is further configured so that the decoding process comprises loop filter processes that apply to the second set of bits and to the first set of bits, a quantization parameter to be used for processing the second set of bits being set equal to a quantization parameter to be used for processing the first of bits set plus a predetermined value.

In an embodiment, the encoded format conforms to the HEVC standard.

In an embodiment, the encoded format conforms to the HEVC RExt standard.

According to a sixth aspect of the invention there is provided a video decoder comprising the device described above.

Since the present invention can be implemented in software, the present invention can be embodied as computer readable code for provision to a programmable apparatus on any suitable carrier medium. A tangible carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Further advantages of the present invention will become apparent to those skilled in the art upon examination of the drawings and detailed description. It is intended that any additional advantages be incorporated herein.

Embodiments of the invention will now be described, by way of example only, and with reference to the following drawings in which:

FIG. 1 schematically illustrates an example of data structure used in HEVC;

FIG. 2 illustrates the architecture of an example of an HEVC video encoder;

FIG. 3 illustrates the architecture of an example of an HEVC video decoder;

FIG. 4, comprising FIGS. 4a and 4b, illustrates the transform and quantization processes as carried out in an encoder and a decoder, respectively;

FIG. 5, comprising FIG. 5a and FIG. 5b, illustrates the main principle of frame re-arrangement, at the encoder and decoder, respectively, according to a particular embodiment of the invention;

and a step of extracting a second set, comprising FIG. 6a, FIG. 6b, and FIG. 6c, illustrates examples of frame re-arrangement according to a particular embodiment of the invention;

FIG. 7 illustrates an example of distribution of sub-samples in components of a color image conforming to the 4:2:2 chroma format that is used to code a high bit-depth monochrome image;

FIG. 8, comprising FIG. 8a and FIG. 8b, illustrates an example of frame re-arrangement when a color image conforming to the 4:2:0 chroma format is used to code a high bit-depth monochrome image;

FIG. 9, comprising FIG. 9a and FIG. 9b, illustrates an example of frame re-arrangement when using a frame packing arrangement;

FIG. 10 illustrates an example of frame re-arrangement when using primary and auxiliary coded images as defined, for example, in AVC standard; and

FIG. 11, comprising FIG. 11a, FIG. 11b, and FIG. 11c, illustrates different possible configurations for re-arranging the bits of a sample into two sub-samples.

### DETAILED DESCRIPTION OF EMBODIMENTS OF THE INVENTION

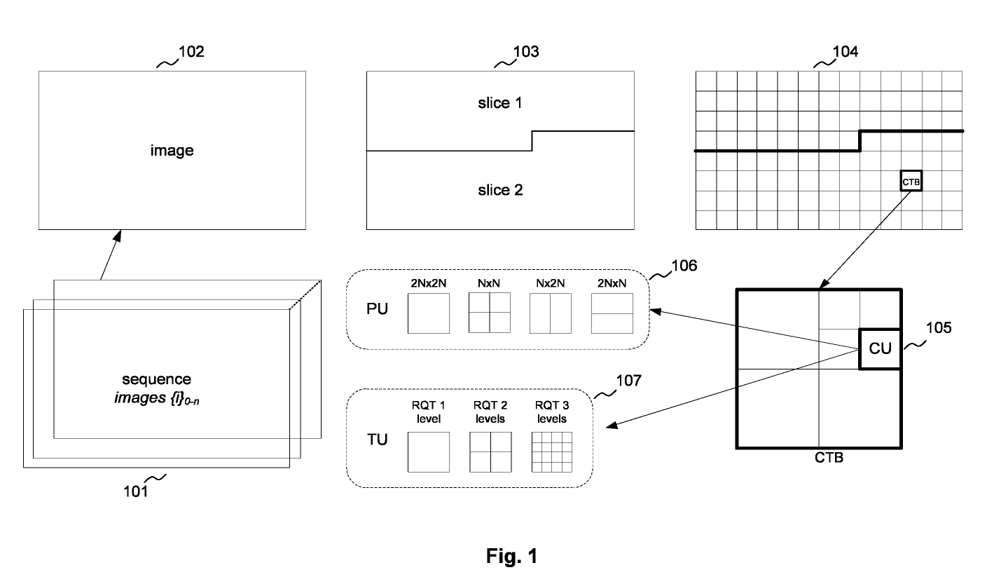

FIG. 1 illustrates an example of coding structure used in HEVC. According to HEVC and one of its previous predecessors, the original video sequence 101 is a succession of digital images “images i”. A digital image is represented by one or more matrices the coefficients of which represent pixels.

It should be noted that the word “image” should be broadly interpreted as video images in the following. For instance, it designates the pictures (or frames) in a video sequence.

The images 102 are divided into slices 103. A slice is a part of the image or the entire image. In HEVC these slices are divided into non-overlapping Largest Coding Units (LCUs), also referred to as Coding Tree Blocks (CTB) 104, generally blocks of size 64 pixels×64 pixels. Each CTB may in its turn be iteratively divided into smaller variable size Coding Units (CUs) 105 using a quadtree decomposition. Coding units are the elementary coding elements and are constituted of two sub-units which are Prediction Units (PU) and Transform Units (TU) of maximum size equal to the CU's size. The prediction Units correspond to the partition of the CU for prediction of pixels values. Each CU can be further partitioned into a maximum of 4 square Partition Units or 2 rectangular Partition Units 106. Transform units are used to represent the elementary units that are spatially transformed with DCT (standing for Discrete Cosine Transform). A CU can be partitioned in TU based on a quadtree representation (107).

Each slice is embedded in one NAL unit. In addition, the coding parameters of the video sequence are stored in dedicated NAL units referred to as parameter sets. In HEVC and H.264/AVC two kinds of parameter set NAL units are employed: first, the Sequence Parameter Set (SPS) NAL unit which comprises all parameters that are unchanged during the whole video sequence. Typically, it handles the coding profile, the size of the video frames and other parameters. Secondly, Picture (Image) Parameter Sets (PPS) code the different values that may change from one frame to another.

An additional structure, referred to as a Tile, is also defined in HEVC. A Tile is a rectangular set of LCUs. The division of each image or slice into tiles is a partitioning. This structure is well adapted to specify Regions of Interest. In HEVC, a Tile is built (coded and decoded) independently from neighbouring tiles of the same image. However a tile may be predicted from several tiles from previously processed images.

In summary, in HEVC, specific syntax headers or parameter sets are defined for the different levels:
video level: a Video Parameter Set (VPS) is defined to specify the structure of the video; a video is made of several layers, corresponding to several versions of the same content, for instance such as different views of the same scene, different spatial resolutions of the same view; the VPS specifies the layered structure of the video content;
sequence level: a Sequence Parameter Set (SPS) is defined to specify the structure of the sequence; in particular it defines the spatial resolution of the images, the frame rate, the chroma format, the bit-depth of luma and chroma samples; an SPS refers to a VPS via a VPS id.
image level: a Picture (Image) Parameter Set (PPS) is defined to specify a set of features relating to images of the sequence; parameters such as the default luma and chroma quantization parameters, the weighted prediction usage, the tiles usage, the loop filtering parameters are signalled in the PPS; a PPS refers to an SPS via an SPS id.
slice level: a Slice Header (referred to as in the HEVC specification as Slice Segment Header) is defined to specify a set of features relating to the Slice of the image; similarly to the PPS, it specifies specific settings for the coding tools, such as the slice type (intra, inter), the reference images used for the temporal prediction, the activation of coding tools, the number and structure of tiles composing the slice; a Slice Segment Header refers to a PPS via a PPS id.

In what follows coding tools and coding modes will be described. Coding tools are the different processes that apply in the coding/decoding processes. For instance, intra coding, inter coding, motion compensation, transform, quantization, entropy coding, deblocking filtering. Coding modes relate to coding tools and correspond to different available parameterizations of these coding tools. For simpler terminology, it is considered that both terms are equivalent and can be used in the same way.

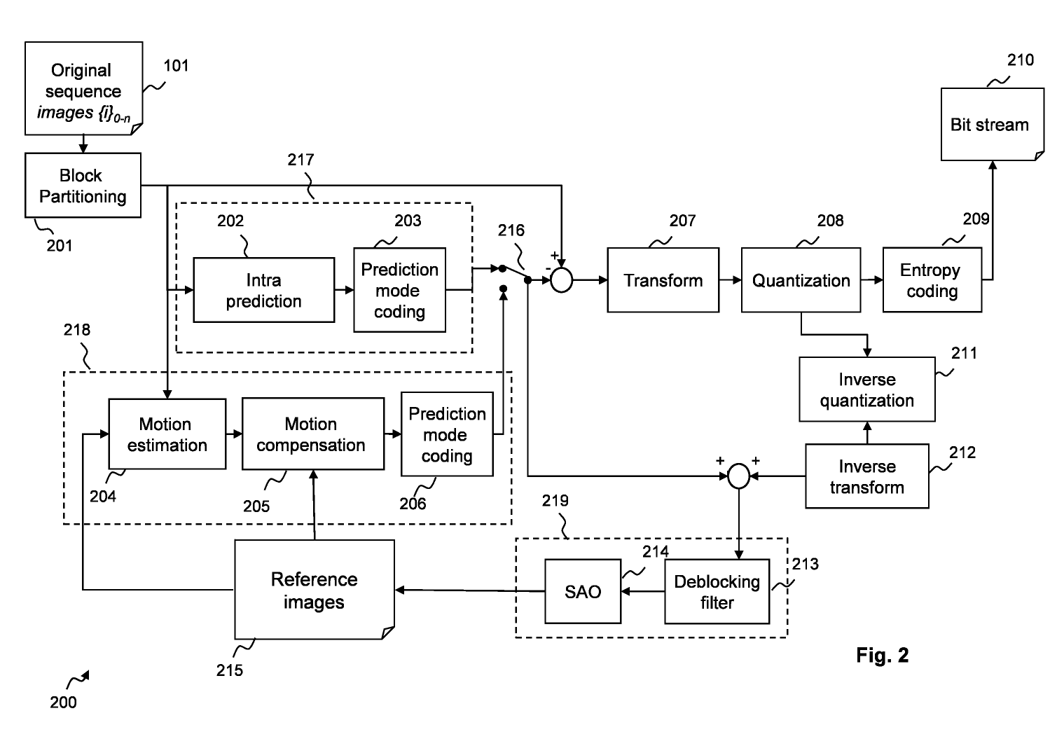

FIG. 2 illustrates a schematic diagram of an example of an HEVC video encoder 200 that can be considered as a superset of one of its predecessors (H.264/AVC).

Each frame of the original video sequence 101 is first divided into a grid of coding units (CU) in a module referenced 201 which is also used to control the definition of the coding slices.

The subdivision of the largest coding units (LCUs) into coding units (CUs) and the partitioning of the coding units into transform units (TUs) and prediction units (PUs) is determined as a function of a rate distortion criterion. Each prediction unit of the coding unit being processed is predicted spatially by an “Intra” predictor during a step carried out in a module referenced 217 or temporally by an “Inter” predictor during a step carried out by a module referenced 218. Each predictor is a block of pixels issued from the same image (i.e. the processed image) or another image, from which a difference block (or “residual”) is derived. Thanks to the identification of a predictor block and a coding of the residual, it is possible to reduce the quantity of information actually to be encoded.

The encoded frames are of two types: temporally predicted frames (either predicted from one reference frame called P-frames or predicted from two reference frames called B-frames) and non-temporally predicted frames (called Intra frames or I-frames). In I-frames, only Intra prediction is considered for coding coding units and prediction units. In P-frames and B-frames, Intra and Inter prediction are considered for coding coding units and prediction units.

In the “Intra” prediction processing module 217, the current block is predicted by means of an “Intra” predictor that is to say a block of pixels constructed from the information already encoded in the current image. More precisely, the module 202 determines an intra prediction mode that is to be used to predict pixels from the neighbouring PU pixels. In HEVC, up to 35 intra prediction modes are considered.

A residual block is obtained by computing the difference between the intra predicted block and the current block of pixels. An intra-predicted block therefore comprises a prediction mode and a residual. The coding of the intra prediction mode is inferred from the neighbours prediction units' prediction mode. This process for inferring a prediction mode, carried out in module 203, enables reduction of the coding rate of the intra prediction mode. Intra prediction processing module uses also the spatial dependencies of the frame either for predicting the pixels but also to infer the intra prediction mode of the prediction unit.

With regard to the second processing module 218 that is directed to “Inter” coding, two prediction types are possible. The first prediction type referred to as mono-prediction and denoted P-type consists of predicting a block by referring to one reference block from one reference image. The second prediction type referred to as bi-prediction (B-type) consists in predicting a block by referring to two reference blocks from one or two reference images.

An estimation of motion between the current prediction unit and blocks of pixels of reference images 215 is made in module 204 in order to identify, in one or several of these reference images, one (P-type) or several (B-type) blocks of pixels to be used as predictors to encode the current block. In cases where several predictors are to be used (B-type), they are merged to generate a single prediction block. It is to be recalled that reference images are images in a video sequence that have already been coded and then reconstructed (by decoding).

The reference block is identified in the reference frame by a motion vector (MV) that is equal to the displacement between the prediction unit in the current frame and the reference block. After having determined a reference block, the difference between the prediction block and current block is computed in module 205 of processing module 218 carrying out the inter prediction process. This block of differences represents the residual of the inter predicted block. At the end of the inter prediction process, the current PU is composed of one motion vector and a residual.

Thanks to spatial dependencies of movements between neighbouring prediction units, HEVC provides a method to predict a motion vector for each prediction unit. To that end, several types of motion vector predictors are employed (generally two types, one of the spatial type and one of the temporal type). Typically, the motion vector associated with the prediction units located on the top, the left, and the top left corner of the current prediction unit form a first set of spatial predictors. A temporal motion vector candidate is generally also used. It is typically the one associated with the collocated prediction unit in a reference frame (i.e. the prediction unit at the same coordinate). According to the HEVC standard, one of the predictors is selected based on a criterion that minimizes the difference between the motion vector predictor and the motion vector associated with the current prediction unit. According to the HEVC standard, this process is referred to as AMVP (standing for Adaptive Motion Vector Prediction).

After having been determined, the motion vector of the current prediction unit is coded in module 206, using an index that identifies the predictor within the set of motion vector candidates and a motion vector difference (MVD) between the prediction unit motion vector and the selected motion vector candidate. The Inter prediction processing module relies also on spatial dependencies between motion information of prediction units to increase the compression ratio of inter predicted coding units.

The spatial coding and the temporal coding (modules 217 and 218) thus supply several texture residuals (i.e. the difference between a current block and a predictor block) which are compared each other in module 216 for selecting the best coding mode that is to be used.

The residual obtained at the end of the inter or intra prediction process is then transformed in module 207. The transform applies to a transform unit that is included into a coding unit. A transform unit can be further split into smaller transform units using a so-called Residual QuadTree decomposition (RQT). According to the HEVC standard, two or three levels of decompositions are generally used and authorized transform block sizes are 32×32, 16×16, 8×8, and 4×4. The transform function is derived from a discrete cosine transform DCT.

The residual transformed coefficients are then quantized in module 208 and the coefficients of the quantized transformed residual are coded by means of entropy coding in module 209 to be added in compressed bit-stream 210. Coding syntax elements are also coded in module 209. This entropy coding module uses spatial dependencies between syntax elements to increase the coding efficiency.

In order to calculate the “Intra” predictors or to make an estimation of the motion for the “Inter” predictors, the encoder performs a decoding of the blocks already encoded. This is done by means of a so-called “decoding” loop carried out in modules 211, 212, 213, and 214. This decoding loop makes it possible to reconstruct blocks and images from quantized transformed residuals.

According to the decoding loop, a quantized transformed residual is dequantized in module 211 by applying an inverse quantization that corresponds to the inverse of the one provided in module 208. Next, the residual is reconstructed in module 212 by applying the inverse transform of the transform applied in module 207.

On the one hand, if the residual comes from an “Intra” coding, that is to say from module 217, the used “Intra” predictor is added to the decoded residual in order to recover a reconstructed block corresponding to the original processed block (i.e. the block lossy modified by transform and quantization modules 207 and 208).

On the other hand, if the residual comes from an “Inter” coding module 218, the blocks pointed to by the current motion vectors (these blocks belong to the reference images 215 referred by the current image indices) are merged before being added to the processed received residual.

A final loop filter processing module 219 is used to filter the reconstructed residuals in order to reduce the effects resulting from heavy quantization of the residuals and thus, reducing encoding artefacts. According to the HEVC standard, several types of loop filters are used among which the deblocking filter and sample adaptive offset (SAO) carried out in modules 213 and 214, respectively. The parameters used by these filters are coded and transmitted to the decoder using a header of the bit stream, typically a slice header.

The filtered images, also called reconstructed images, are stored as reference images 215 in order to allow the subsequent “Inter” predictions taking place during the compression of the following images of the current video sequence.

In the context of HEVC, it is possible to use several reference images 215 for the estimation of motion vectors and for motion compensation of blocks of the current image. In other words, the motion estimation is carried out on a set of several images. Thus, the best “Inter” predictors of the current block, for the motion compensation, are selected in some of the multiple reference images. Consequently two adjoining blocks may have two predictor blocks that come from two distinct reference images. This is in particular the reason why, in the compressed bit stream, the index of the reference image (in addition to the motion vector) used for the predictor block is indicated.

The use of multiple reference images (the Video Coding Experts Group recommends limiting the number of reference images to four) is useful for withstanding errors and improving the compression efficiency.

It is to be noted that the resulting bit stream 210 of the encoder 200 comprises a set of NAL units that corresponds to parameter sets and coding slices.

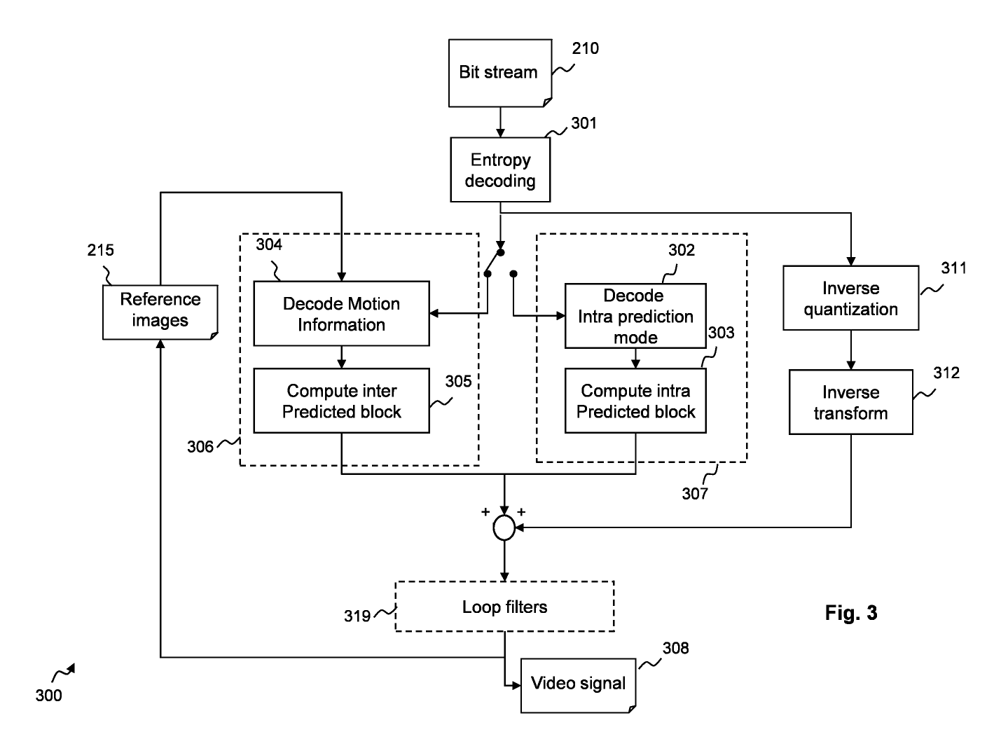

FIG. 3 illustrates a schematic diagram of a video decoder of the HEVC type. The illustrated decoder 300 receives as an input a bit stream, for example the bit stream 210 corresponding to video sequence 101 compressed by encoder 200 of the HEVC type as described by reference to FIG. 2.

During the decoding process, the bit stream 210 is parsed in an entropy decoding module 301. This processing module uses the previously entropy decoded elements to decode the encoded data. In particular, it decodes the parameter sets of the video sequence to initialize the decoder. It also decodes largest coding units of each video frame. Each NAL unit that corresponds to coding slices are then decoded.

The partition of a current largest coding unit is parsed and the subdivisions of coding units, prediction units, and transform units are identified. The decoder successively processes each coding unit in intra processing module 307 or inter processing module 306 and in inverse quantization module 311, inverse transform module 312, and loop filter processing module 319.

It is to be noted that inverse quantization module 311, inverse transform module 312, and loop filter processing module 319 are similar to inverse quantization module 211, inverse transform module 212, and loop filter processing module 219 as described by reference to FIG. 2.

The “Inter” or “Intra” prediction mode for the current block is parsed from the bit stream 210 in parsing process module 301. Depending on the prediction mode, either intra prediction processing module 307 or inter prediction processing module 306 is selected to be used.

If the prediction mode of the current block is “Intra” type, the prediction mode is extracted from the bit stream and decoded with help of neighbours' prediction mode in module 304 of intra prediction processing module 307. The intra predicted block is then computed in module 303 with the decoded prediction mode and the already decoded pixels at the boundaries of current prediction unit. The residual associated with the current block is recovered from the bit stream and then entropy decoded in module 301.

On the contrary, if the prediction mode of the current block indicates that this block is of the “Inter” type, the motion information is extracted from the bit stream and decoded in module 304 and the AMVP process is carried out. Motion information of the neighbouring prediction units already decoded are also used to compute the motion vector of the current prediction unit. This motion vector is used in the reverse motion compensation module 305 in order to determine the “Inter” predictor block contained in the reference images 215 of the decoder 300. In a similar way to what is done in the encoder, the reference images 215 are composed of images that precede the image currently being decoded and that are reconstructed from the bit stream (and therefore decoded previously).

A following decoding step consists in decoding a residual block corresponding to the current coding unit, that has been transmitted in the bit stream. The parsing module 301 extracts the residual coefficients from the bit stream and performs successively an inverse quantization in module 311 and an inverse transform in module 312 to obtain the residual block. This residual block is added to the predicted block obtained at output of intra or inter processing module.

After having decoded all the blocks of a current image, loop filter processing module 319 is used to eliminate block effects and to reduce encoding artifacts in order to obtain reference images 215. Like the encoder and as described by reference to FIG. 2, loop filter processing module 319 may comprise a deblocking filter and sample adaptive offset.

As illustrated, the decoded images are used as an output video signal 308 of the decoder, which can then be displayed.

As mentioned above, the transform carried out in module 207 and the inverse transform carried out in modules 212 and 312 can apply to blocks having a size varying from 4×4 to 32×32. It is also possible to skip the transform for 4×4 blocks when it turns out that the transformed coefficients are more costly to encode than the non-transformed residual signal (this is known as the Transform-Skip mode).

The DCT-like transform matrices used in HEVC are all derived from a 32×32 matrix denoted T_{32×32} whose content is given in the Appendix. The transform matrix of size N×N (N=4, 8, 16) is generally derived from the T_{32×32} transform matrix according to the following relation:

T_{N×N}[x,y]=T_{32×32}[x,y*R] with R=N/32, for x=0 . . . N−1 and y=0 . . . N−1

For 4×4 blocks, it is also possible to use a DST-like transform as defined in the Appendix.

Quantization parameters are used to control the quantization process and the deblocking filtering process. They can vary from one coding unit to another coding unit. According to the HEVC standard, a first set quantization parameters, common for all the coding units of a slice, are signalled within the bit stream and if required, further delta quantization parameters are transmitted, one per coding unit.

Regarding the quantization process, the quantization parameter referred to as QP_{CU} that is associated with a particular coding unit does not directly apply. Quantization is done by using a quantization parameter referred to as QP which depends on the input quantization parameter QP_{CU} and the bit-depth B according to the following relation:

QP=QP_{CU}+6·(B−8)

Regarding the deblocking filter, the input quantization parameter known as QP_{CU} is used without any change.

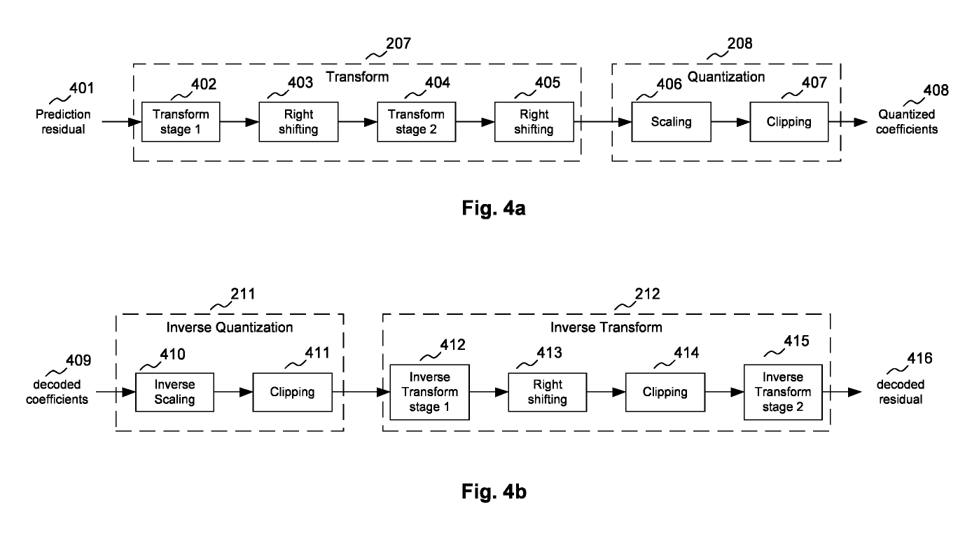

FIG. 4, comprising FIGS. 4a and 4b, illustrates the transform and quantization processes as carried out in an encoder and a decoder, respectively.

For the sake of illustration, it is considered that the prediction residual block to be processed denoted R and referenced 401 in FIG. 4, R is the output of a prediction process, for example the output of module 217 or 218 described by reference to FIG. 2 depending on the coding mode. It is assumed that the size of R is N×N, N being equal to 2ⁿ, and that B is the bit-depth of the image data.

Regarding the encoder and as illustrated in FIG. 4a, a first step (step 402) aims at computing a block of transform coefficients D1. It may be computed according to the following relation:

D1=T_{N×N}×R^{t}

where ‘t’ is the matrix transposition operator and ‘x’ the matrix multiplication operator.

Next, in step 403, each sample of the block of transform coefficients D1 is shifted according to the following relation:

C1[x,y]=D1[x,y]>>(n+B−9)

which means that each bit of each sample of the block of transform coefficients D1 is shifted (n+B−9) bits to the right (the (n+B−9) least significant bits being withdrawn).

After block D1 samples having been shifted, the resulting block C1 is used to compute a block of transform coefficients D2 according to the following relation (step 404):

D2=T_{N×N}×C1^{t}

Next, in step 405, each sample of the block of transform coefficients D2 is shifted according to the following relation:

C2[x,y]=D2[x,y]>>(n+6)

which means that each bit of each sample of the block of transform coefficients D2 is shifted (n+6) bits to the right (the (n+6) least significant bits being withdrawn).

It is to be noted that if the Transform Skip mode is to be used, steps 402 to 405 are replaced by a single step according to which the resulting block C2 is obtained by shifting the prediction residual block R according to the following relation:

C2[x,y]=R[x,y]<<(15−n−B)

which means that each bit of each sample of the prediction residual block R is shifted (15−n−B) bits to the left).

Next, in step 406, each coefficient of the resulting block C2 is quantized according to the following relation:

C3[x,y]=(C2[x,y]·qScale[QP%6]+rnd)>>(14+QP/6+tShift)

where QP is the Quantization Parameter used in the quantization process, tShift is a variable set to the value (15−n−B), and rnd is a rounding parameter and where qScale is an array defined as follows:

qScale[k]=INT{(2⁶·2¹⁴)/levScale[QP%6]}

where INT{·} is the nearest integer operator and levScale[ ] is defined as follows:

levScale[k]={40,45,51,57,64,72} with k=0 . . . 5.

This actually leads to the following definition:

qScale[k]={26214,23302,20560,18396,16384,14564} with k=0 . . . 5.

After having quantized the coefficients of the resulting block C2, each coefficient of the resulting block C3 is clipped (step 407). According to the HEVC standard, each value C3[x, y] is clipped between −32,768 and 32,767 (i.e. between −2¹⁵ to 2¹⁵−1). The clipped values represent the quantized coefficients 408.

It is to be recalled that the clipping operation of a variable x between values A and B, with B>=A, consists in forcing the value of x to A or B if it does not belong to the range [A; B] as follows:
if x<A, x=A;
otherwise if x>B, x=B;
otherwise, x is not modified.

The quantized coefficients are encoded (entropy encoding) and transmitted to the decoder within the bit stream.

Accordingly, at the decoder end, block of decoded coefficients Q, referenced 409 in FIG. 4b, actually corresponding to block C3 as described above by reference to FIG. 4a, can be obtained from an entropy decoder, for example the entropy decoder 301 described by reference to FIG. 3.

After having been obtained, each of the decoded quantized coefficients is dequantized according to the following relation (step 410):

d[x,y]={[Q[x,y]·m[x,y]·levScale[QP%6]<<(QP/6)]+(1<<(bdS−1))}>>bdS

where bdS is set to the value (B+n−5) and m[x, y] is a coefficient of a scaling matrix that is received within the bit stream. By default (i.e. when no quantization matrix is used), m[x, y] is set to the value 16 (m[x, y]=16).

Next, in step 411, each of the dequantized coefficients d[x, y] is clipped between −32,768 and 32,767 (i.e. between −2¹⁵ to 2¹⁵−1). Resulting values are stored in block of decoded coefficients Q (replacing the decoded values).

Next, in step 412, a block of transform coefficients E1 is computed as a function of the block Q of dequantized and clipped coefficients and of the transform matrix T_{N×N} according to the following relation:

E1^{t}=T_{N×N}^{t}×Q

Each sample of E1 is then shifted in step 413 according to the following relation:

G[x,y]=(E1[x,y]+64)>>7

which means that value 64 is added to the processed sample and that each bit of the processed sample is shifted seven bits to the right (the seven least significant bits being withdrawn).

Each resulting value G[x, y] is then clipped in step 414 between −32,768 and 32,767 (i.e. between −2¹⁵ to 2¹⁵−1).

Next, in step 415, the block of decoded residual samples E2, denoted 416 in FIG. 4b, is computed as a function of the clipped resulting value G and of the transform matrix T_{N×N} according to the following relation:

E2^{t}=T_{N×N}^{t}×G

If the Transform Skip mode is to be used, steps 411 to 415 are replaced by a single step according to which each sample of the decoded residual samples E2 is obtained by shifting the corresponding decoded quantized coefficient Q[x, y] according to the following relation:

E2[x,y]=Q[x,y]<<7

Despite the advantages offered by the HEVC standard, it has been primarily designed to handle only 8 bit-depth content, most of the intermediate computations involved in the transform/inverse transform processes being achieved using 16-bit integer registers. The Range Extension of HEVC enables to support more than 8-bits but when reaching more than 12 bits, it is no more possible to guaranty that internal computations can be achieved using 16-bit integer registers.

If such a feature can be considered as offering satisfactory results for data bit-depth coded on 12 bits or less, higher bit-depth leads to problems that are linked, in particular, to the transform process to be applied because of the right shifting and clipping sub-processes that may cause important losses, even before applying the quantization process.

Therefore, the transform process conforming to the current HEVC standard is not adapted to handle high bit-depth content, especially when 16-bits content are considered, which can be encountered for instance in medical applications.

According to a particular embodiment, the samples of the input picture are split into two sub-pictures of lower bit-depth. The sub-pictures are then packed in an adequate format to obtain new pictures of more limited bit-depth that can be efficiently coded using existing HEVC coding tools. At the decoder end, the obtained decoded packed pictures of more limited bit-depth are unpacked to re-generate a picture of the original bit-depth. This applies, in particular, to medical content generally represented as 16-bits monochrome (4:0:0 color format) pictures or videos.

A first embodiment is directed to monochrome pictures of bit-depth B that are converted into pairs of monochrome sub-pictures that are packed together into a color format to form single color pictures whose components are of lower bit-depth than B. At the decoder end, the components of the decoded color pictures are re-arranged and merged into a reconstructed monochrome picture.

In an embodiment, when the input images are colour images of high bit-depth, made of at least two colour components, each one of the components of the colour images are considered as a monochrome image.

It is to be recalled that according to the HEVC standard, a picture is defined as an array of luma samples in monochrome format or an array of luma samples (denoted Y) and two corresponding arrays of chroma samples (denoted U or Cr and V or Cb) in color format. Different sampling ratios can be used for the three components of a color picture that are generally processed separately in image and video compression.

The subsampling scheme is commonly expressed as a three part ratio J:a:b (e.g. 4:2:2) that describes the number of luminance and chrominance samples in a theoretical region that is J pixels wide and 2 pixels high. The J value corresponds to the horizontal sampling reference (i.e. width of the conceptual region). It is generally equal to four. The a value represents the number of chrominance samples (Cr, Cb) in the first row of J pixels and the b value represents the number of (additional) chrominance samples (Cr, Cb) in the second row of J pixels.

According to the 4:2:0 YUV chroma format, the number of U and V components regarding width and height are W/2 and H/2 if the number of Y components regarding width and height are W and H, respectively.

Likewise, according to the 4:2:2 YUV chroma format, the number of U and V components regarding width and height are W/2 and H if the number of Y components regarding width and height are W and H, respectively.

Similarly, according to the 4:4:4 YUV chroma format, the number of U and V components regarding width and height are W and H if the number of Y components regarding width and height are W and H, respectively. This is the same for the 4:4:4 RGB chroma format.

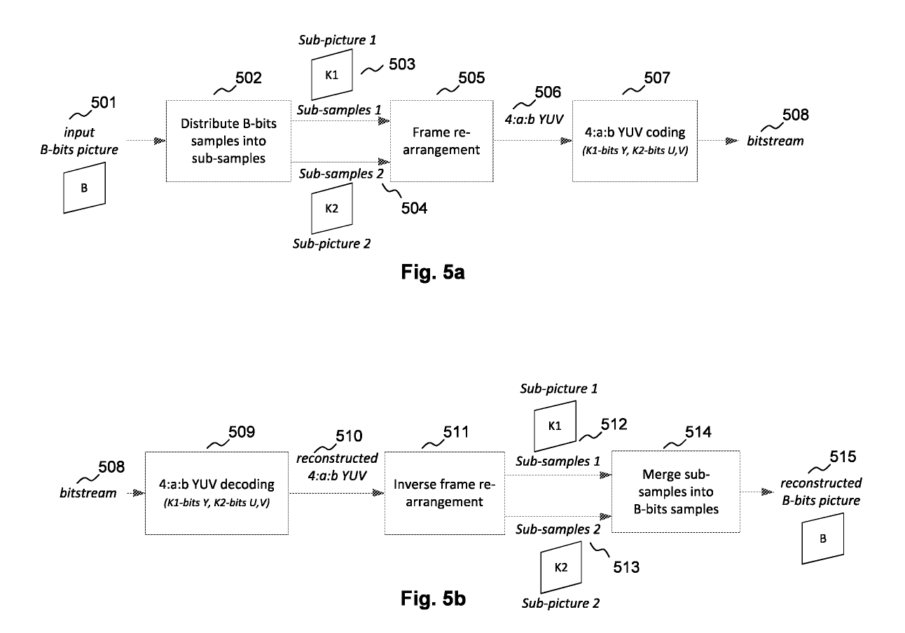

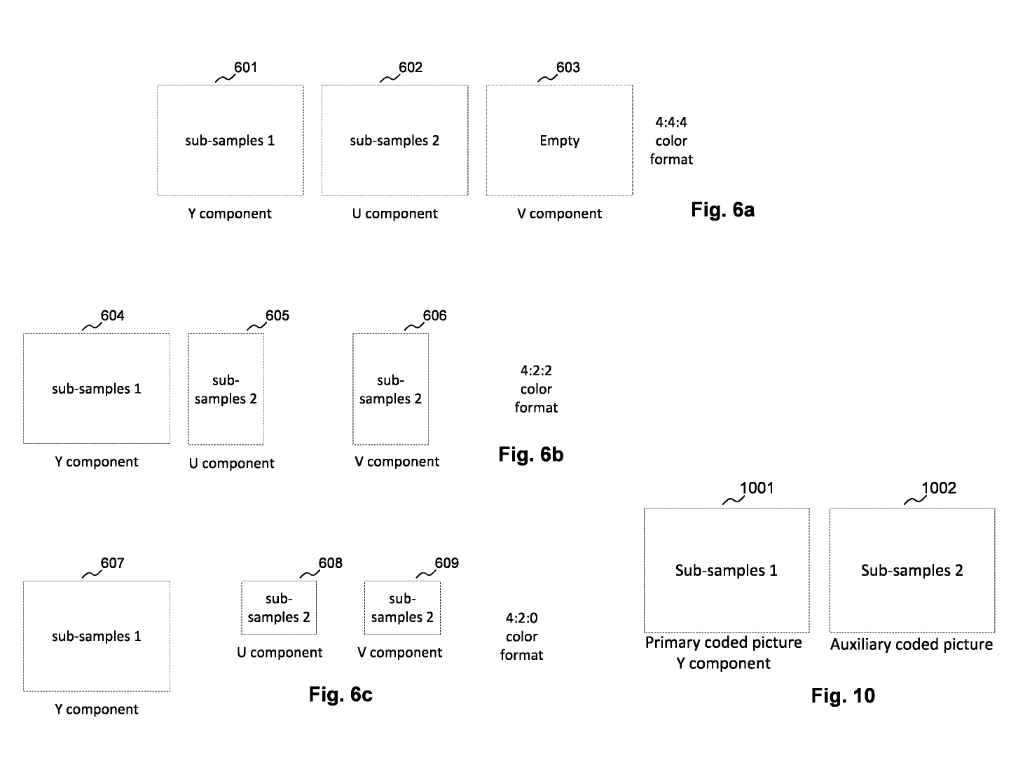

FIG. 5, comprising FIG. 5a and FIG. 5b, illustrates the main principle of frame re-arrangement, at the encoder and decoder, respectively, according to a particular embodiment of the invention.

FIG. 5a schematically illustrates frame re-arrangement in an encoder. According to this embodiment, the input of the encoder mainly consists in monochrome pictures of bit-depth equal to B, referenced 501 in FIG. 5a.

According to first step (step 502), each sample of an input picture is split into two sub-samples of bit-depth lower than B. As a result, two monochrome sub-images denoted sub-image 1 and sub-image 2 and referenced 503 and 504 in FIG. 5a are obtained for a given input picture: sub-picture 1 comprises a set of sub-samples comprising a first sub-sample of each sample of the input image, denoted sub-samples 1, and sub-picture 2 comprises a set of sub-samples comprising a second sub-sample of each sample of the input image, denoted sub-samples 2.

Next, in step 505, the sub-samples of these two monochrome images are packed together in a color picture made of luma and chroma components. This process results in a color picture referenced 506 in FIG. 5b of format 4:a:b YUV, in which:
4:a:b can be one of the color formats 4:2:0, 4:2:2 or 4:4:4;
the Y (luma) component is of bit-depth K1 with K1<B; and
the U and V (chroma) components are of bit-depth K2 with K2<B and K1+K2≧B.

The color picture 506 is then encoded in step 507 to be transmitted in a bit stream referenced 508 in FIG. 5b.

FIG. 5b schematically illustrates frame re-arrangement in a decoder. As illustrated, the re-arrangement process carried out in the decoder is symmetrical to the one carried out in the encoder.

As illustrated, the received bit stream 508 is decoded in step 509 using a standard 4:a:b YUV decoder where Y is represented on K1 bits and U and V on K2 bits.

The decoded pictures of format 4:a:b YUV, referenced 510 in FIG. 5b, are then unpacked in step 511 to obtain two sets of sub-pictures. A first set of sub-pictures 512 comprises first sets of sub-samples comprising a first sub-sample of each sample of the original images. Likewise, a second set of sub-pictures 513 comprises second sets of sub-samples comprising a second sub-sample of each sample of the original images. The first and second sub-samples are coded on K1 and K2 bits respectively.

Next, sub-pictures of the first set of sub-pictures are merged with corresponding sub-pictures of the second set of sub-pictures in step 514 to reconstruct the original images 515 that bit-depth is equal to B.

FIG. 6, comprising FIG. 6a, FIG. 6b, and FIG. 6c, illustrates examples of frame re-arrangement according to a particular embodiment of the invention.

In the example illustrated in FIG. 6a, the color picture used to code a high bit-depth monochrome picture is an image conforming to the 4:4:4 chroma format. Each sample of the original monochrome picture is split into two sub-samples (sub-sample 1 and sub-sample 2). Sub-samples 1 are put in Y component 601 of the color image used to code the original image and sub-samples 2 are put in U component 602 of the color image. According to this example, V component 603 does not contain any data from the original picture. As a consequence, all its samples are set to a pre-defined default value that can be, for example 0 or 2^{K2-1} which is the usual neutral value for U or V components.

In the example illustrated in FIG. 6b, the color picture used to code the high bit-depth monochrome picture is an image conforming to the 4:2:2 chroma format. Again, each sample of the original monochrome picture is split into two sub-samples (sub-sample 1 and sub-sample 2). According to this example, sub-samples 1 are put in Y component 604 of the color image used to code the original image and sub-samples 2 are distributed and stored in two sub-pictures of half width corresponding to U and V components 605 and 606 of the color image.

In a particular embodiment, sub-samples 2 stored in U component correspond to the even lines of sub-picture 2 and sub-samples 2 stored in V component correspond to the odd lines of sub-picture 2.

In another particular embodiment, sub-samples 2 stored in U component correspond to the even columns of sub-picture 2 and sub-samples 2 stored in V component correspond to the odd columns of sub-picture 2.

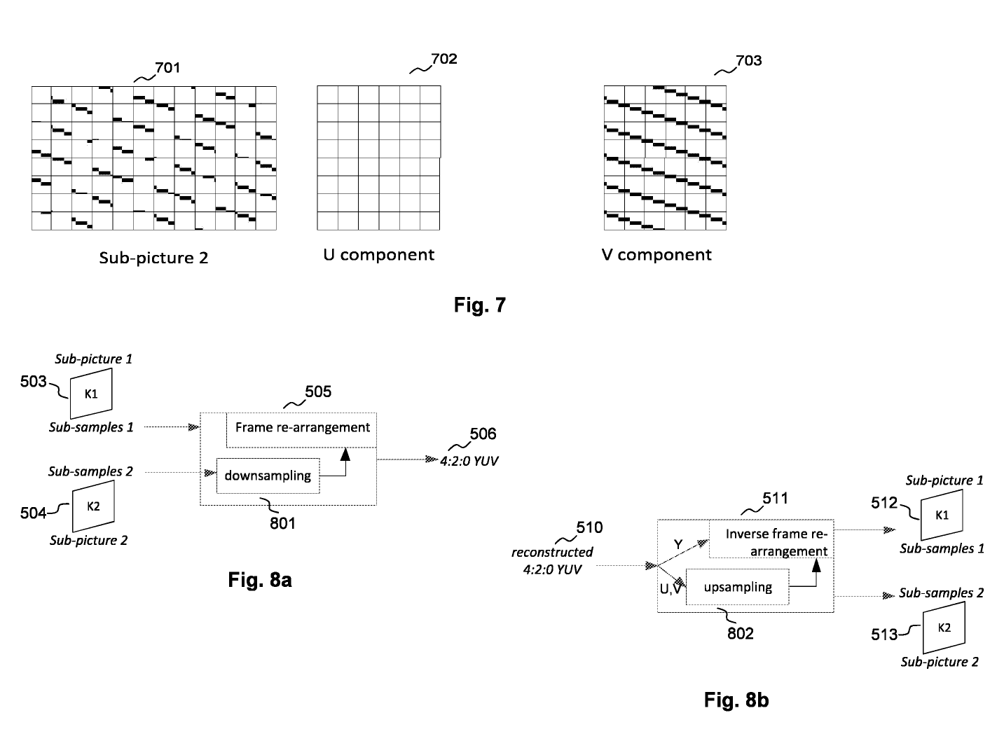

Still in another particular embodiment, the sub-samples of the sub-picture 2 are alternatively put in U and V components, as illustrated in FIG. 7. According to the illustrated example, white sub-samples of sub-picture 2 are stored in U component 702 and dashed sub-samples of sub-picture 2 are stored in V component 703.

In the example illustrated in FIG. 6c, the color picture used to code the high bit-depth monochrome picture is an image conforming to the 4:2:0 chroma format. Again, each sample of the original monochrome picture is split into two sub-samples (sub-sample 1 and sub-sample 2). According to this example, sub-samples 1 are stored in Y component 607 of the color image used to code the original image and sub-samples 2 are distributed and stored in two sub-pictures of half height and half width corresponding to U and V components 608 and 609 of the color image. In such a case, since the number of samples in U and V components is half the number of samples in sub-picture 2, it is required to down-sample the samples from sub-picture 2 inside the frame re-arrangement process 505 at the encoder end. Symmetrically, in the inverse frame re-arrangement 511 of the decoder, an upsampling process must be applied.

FIG. 8, comprising FIG. 8a and FIG. 8b, illustrates an example of frame re-arrangement when a color image conforming to the 4:2:0 chroma format is used to code a high bit-depth monochrome picture.

As illustrated in FIG. 8a that is directed to an encoder, sub-pictures 1 and 2, referenced 503 and 504, are used as inputs for the frame re-arrangement process carried out at step 505 described by reference to FIG. 5. According to this particular embodiment, the frame re-arrangement process further comprises a down-sampling step 801 that applies to each of the sub-samples stored in sub-picture 2. The result of the frame re-arrangement process is the output picture 506 that conforms to the 4:2:0 chroma format.

As illustrated in FIG. 8b that is directed to a decoder, pictures 510 conforming to the 4:2:0 chroma format are reconstructed from a received bit stream (not represented) and used as inputs of inverse frame re-arrangement process 511 (described by reference to FIG. 5). As illustrated, U and V components are up-sampled during step 802 before being unpacked with Y component. This results in the sub-pictures 1 and sub-pictures 2 referenced 512 and 513.

According to a particular embodiment, the frame re-arrangement is based on a frame packing arrangement SEI (Supplemental Enhancement Information) message. In this embodiment the bit-depth values K1 and K2 must be equal each other and represent the maximum bit-depth of the re-arranged frames. The original high bit-depth pictures can be monochrome pictures or color pictures. For the sake of illustration, the maximum bit-depth of the original picture data is B.

If the original picture to be transmitted is a monochrome picture, the two sub-pictures of lower bit-depth that are used to transmit the original picture are monochrome pictures and conversely, if the original picture is a color picture, the two sub-pictures of lower bit-depth are color pictures.

It is to be recalled that according to the HEVC standard, it is possible to transmit specific NAL units, called SEI messages of different types. SEI messages contain information related to the display process. One of them is of the frame_packing_arrangement type (payloadType number 45). This SEI message includes the syntax element ‘content_interpretation_type’ which indicates the type of frame packing arrangement to apply.

In the frame packing arrangement, it is admitted that there are two constituent frames that are referred to as frame 0 and frame 1. The SEI message indicates how these two frames have to be re-arranged before being displayed.

Two types of frame packing arrangements are currently defined for handling pair of stereo frames:
the two frames are left and right views of a stereo view scene with frame 0 being associated with the left view and frame 1 being associated with the right view; and
the two frames are right and left views of a stereo view scene with frame 0 being associated with the right view and frame 1 being associated with the left view.

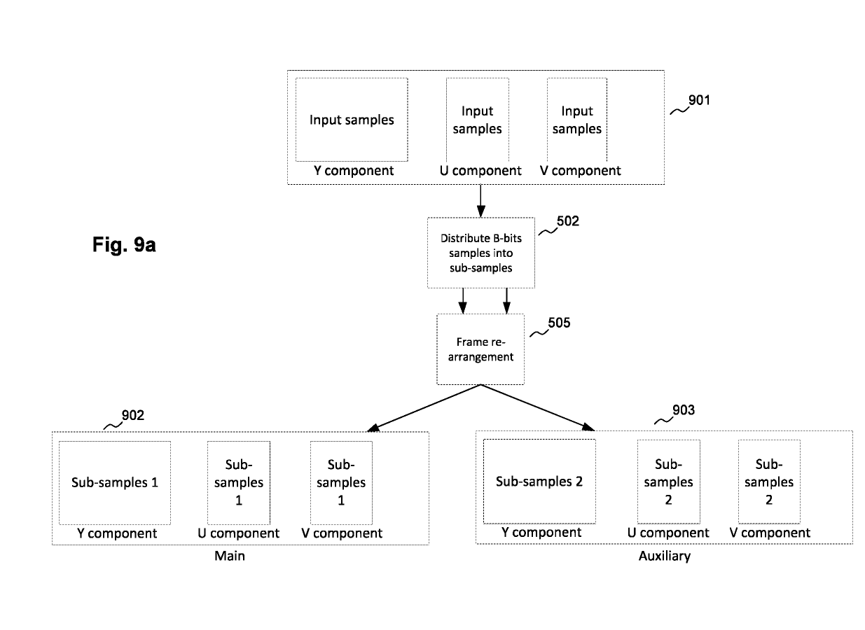

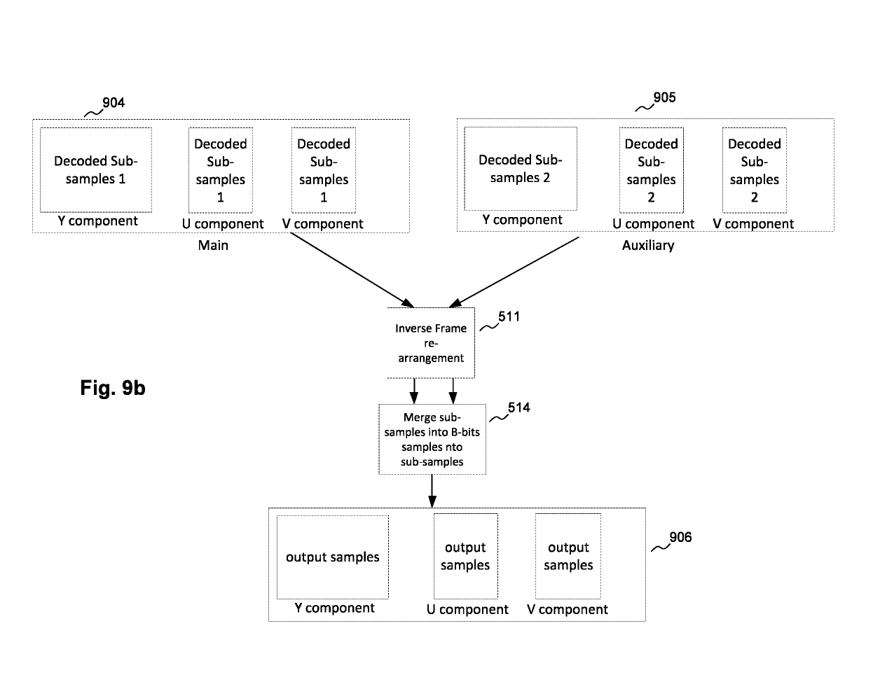

FIG. 9, comprising FIG. 9a and FIG. 9b, illustrates an example of frame re-arrangement when using frame packing arrangement.

For the sake of illustration, the maximum data bit-depth of the original pictures to be transmitted is equal to B, these pictures conforming to the 4:2:2 chroma format. As illustrated in FIG. 9a, each of the Y, U, and V samples of the original picture 901 are split into two sub-samples (sub-sample 1 and sub-sample 2) during step 502 (generically described by reference to FIG. 5). It is to be noted that if the current original picture is a monochromatic picture, only the luma samples have to be split into two sub-samples.

Next, the sub-samples are packed in step 505 (generically described by reference to FIG. 5) such that sub-samples 1 are stored in Y, U, and V components of a first frame 902, corresponding to a main frame also denoted frame 0 or main view, conforming to the 4:2:2 chroma format, and that sub-samples 2 are stored in Y, U, and V components of a second frame 903, corresponding to an auxiliary frame also denoted frame 1 or auxiliary view, conforming to the 4:2:2 chroma format.

Upon reception of such main and auxiliary frames, a process corresponding to the inverse of the one illustrated in FIG. 9a is carried out as illustrated in FIG. 9b.

Accordingly, sub-samples stored in the decoded main frame 904 and in the decoded auxiliary frame 905 are processed during step 511 (generically described by reference to FIG. 5) to be rearranged. Next, in following step 514 (generically described by reference to FIG. 5), the rearranged sub-samples are merged to generate a final output picture 906 corresponding to the original picture. The maximum data bit-depth of the output picture 906 is equal to B.

Indicating that two frames are a main and an auxiliary pictures having a maximum data bit-depth equals to K1, that can be used to reconstruct an original picture having a maximum data bit-depth equals to B (B being larger than K1) and indicating that the main frame corresponds to frame 0 and that the auxiliary frame corresponds to frame 1 can be done by using syntax element ‘content_interpretation_type’ as defined in the HEVC standard. In such a case, the value of syntax element ‘content_interpretation_type’ can be set to 3 (values 1 and to 2 being already used for handling stereo views).

The table representing the semantics of the syntax element ‘content_interpretation_type’ in HEVC can be extended as shown below (in bold font):

| Value | Interpretation |
|---|---|
| 0 | Unspecified relationship between the frame packed constituent |
| | frames |
| 1 | Indicates that the two constituent frames form the left and right |
| | views of a stereo view scene, with frame 0 being associated |
| | with the left view and frame 1 being associated with the |
| | right view |
| 2 | Indicates that the two constituent frames form the right and left |
| | views of a stereo view scene, with frame 0 being associated |
| | with the right view and frame 1 being associated with the |
| | left view |
| 3 | Indicates that the two constituent frames form the main and |
| (new) | auxiliary views of maximum bit-depth K1 of a frame of bit-depth |
| | B larger than K1, with frame 0 being associated with the main |
| | view and frame 1 being associated with the auxiliary view |

Another embodiment applies to monochrome and color pictures. It mainly consists in coding the monochrome or color sub-pictures as a main and an auxiliary frames of lower bit-depth using the AVC auxiliary picture or the Frame packing arrangement concepts. At the decoder end, the obtained decoded pictures of lower bit-depth are re-arranged and merged to generate a picture of bit-depth B.

It is to be recalled that AVC standard specifies the use of an auxiliary coded picture. An auxiliary picture is an extra monochrome picture that supplements the main picture (also called the primary coded picture) which contains texture information (monochrome or color) sent along with the main video stream. It can be used, for instance, as alpha blend.

According to the AVC standard, the auxiliary coded picture must be of the same size as the one of the primary coded picture. Such a concept of using auxiliary coded pictures in the HEVC standard is under discussion in the standardization group.

FIG. 10 illustrates an example of frame re-arrangement when using primary and auxiliary coded pictures as defined, for example, in AVC standard.

As illustrated, Y component of a primary picture (that is preferably monochrome but that can also be a colour picture) corresponds to the sub-samples of sub-picture 1, referenced 1001, while the auxiliary picture contains the sub-samples of sub-picture 2, referenced 1002. As described above, sub-picture 1 and sub-picture 2 are obtained from an original picture to be transmitted by splitting each sample in two sub-samples. Bit-depth B of the samples of the original picture is higher than each of the bit-depths K1 and K2 of the sub-samples.

According to a particular embodiment, the bit-depth of the auxiliary coded picture can be different from the bit-depth of the primary coded picture. For instance, K1 (that corresponds to the bit-depth of the primary coded picture) can be set to 12 while K2 (that corresponds to the bit-depth of the auxiliary coded picture) can be set to 8.

In another embodiment, K1 and K2 are set equal each other and the sub-pictures 1 and 2 are successively coded as successive pictures.

According to a particular embodiment, the bits of each sample of the original picture are split into two sets of bits according to their position in the sample. Accordingly, the number B of bits of each sample is split into a number A of most significant bits (MSBs) and a number (B−A) of least significant bits (LSBs).

Therefore, sets of A MSBs bits are put into sub-samples of K1 bits and sets of (B−A) LSBs bits are put into sub-samples of K2 bits.

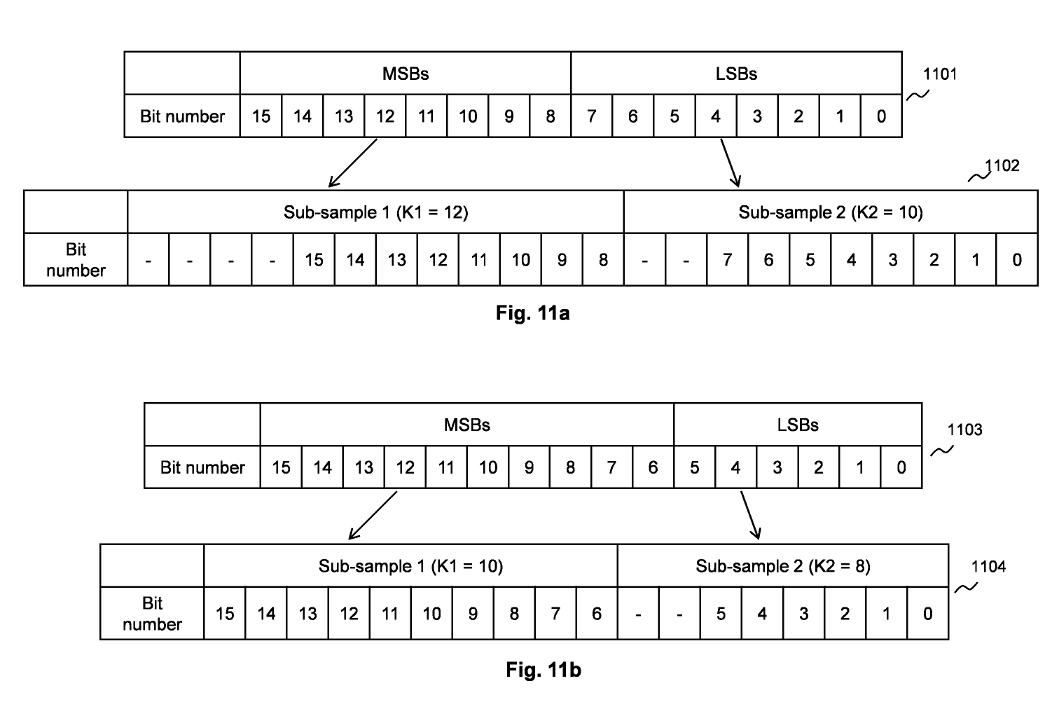

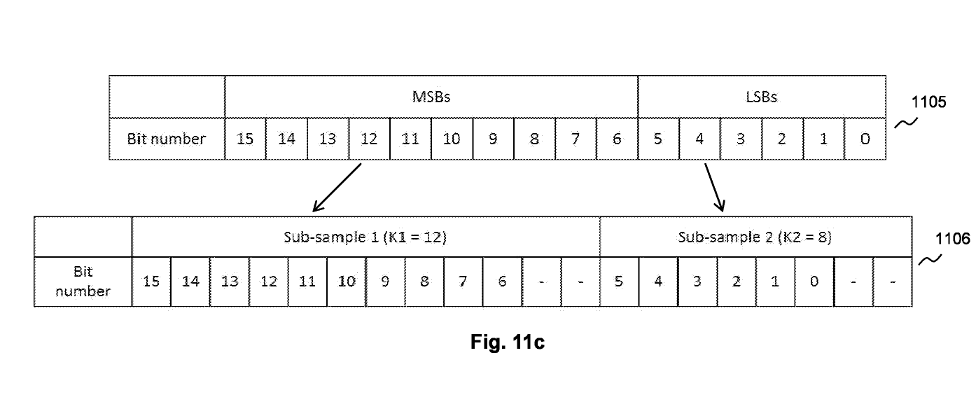

FIG. 11, comprising FIG. 11a, FIG. 11b, and FIG. 11c, illustrates different possible configurations for re-arranging the bits of a sample into two sub-samples. For the sake of illustration, the input sample comprises B bits with B=16 (i.e. bit-depth=16).

According to a first example illustrated in FIG. 11a, an input sample referenced 1101 is split into 8 MSBs and 8 LSBs. MSBs are put into a 12-bit sub-sample (K1=12) and LSBs are put into a 10-bit sub-sample (K2=10). Accordingly, some bits of the sub-samples referenced 1102 are actually empty and are preferably filed with value 0 (not represented for the sake of clarity).

According to a second example illustrated in FIG. 11b, an input sample referenced 1103 is split into 10 MSBs and 6 LSBs. MSBs are put into a 10-bit sub-sample (K1=10) and LSBs are put into a 8-bit sub-sample (K2=8). Again, some bits of the sub-samples referenced 1104 are actually empty and are preferably filed with value 0 (not represented for the sake of clarity).

By considering that each sample of an original picture, coded on B bits, is split into two sets of bits, one comprising a number A of most significant bits and the other a number C=(B−A) of least significant bits, with A<B, a residual value R can be decomposed as an MSBs part and an LSBs part according to the following relation:

R=R_{LSB}+2^{C}R_{MSB}

This implies that the quantization step (QS) to be applied to the least significant bits must be 2^{C} larger than the quantization step (QS) to be applied to the most significant bits, which can be expressed as follows:

QS_{LSB}=2^{C}·QS_{MSB}

As stated above, the quantization step depends on the quantization parameter (QP) according to a relation of the following type:

QS=K·2^{(QP/6)}

where K is a constant that is independent from the QP.

Accordingly, it is possible to establish the following relation:

2^{(QP}^{_{LSB}}^{/6)}=2^{C}·2^{(QP}^{_{MSB}}^{/6)}

Which, in turn, leads to the following relation:

QP_{LSB}=QP_{MSB}+6·C

Therefore, according to a particular embodiment, the quantization parameter applied for the U and V components is higher than the quantization parameter applied for the Y component.

Still according to a particular embodiment, the quantization parameter applied for the U and V components is equal to the quantization parameter applied for the Y component plus (6·C).

The splitting step and the corresponding relations can be generalized as described herein below. An example of such a generalized splitting step is illustrated in FIG. 11c.

It is considered that the samples of B bits (referenced 1105) are split into two sets (referenced 1106):
a first set of sub-samples each comprising a number A of most significant bits, represented on K1 bits, with K1≧A. If K1>A, the A bits are put as the most significant bits of the K1 bits, as shown in FIG. 11c; and
a second set of sub-samples each comprising a number C=(B−A) of least significant bits, represented on K2 bits, with C≦A and K2≧C. Again, similarly if K2>C, the C bits are put as the most significant bits of the K2 bits, as shown in FIG. 11c.

It is noticed that the bits are inserted on the left of the sub-samples (MSBs). This configuration advantageously increases the efficiency of the coding.

The residual value R can be decomposed as a most significant bit part and a least significant bit part according to the following relation:

R=R_{LSB}+2^{C}R_{MSB}

However, what is actually coded can be expressed as follows:

R′_{MSB}=2^{(K1-A)}R_{MSB}

R′_{LSB}=2^{(K2-C)}R_{LSB}

Accordingly, the residual value R can be expressed according to the following relation:

R=2^{(C-K2)}R′_{LSB}+2^{C}2^{(A-K1)}R′_{MSB}

which leads to

2^{(C-K2)}QS_{LSB}=2^{C}2^{(A-K1)}QS_{MSB}

Since QS=K·2^{(QP/6)}, where K is a constant independent from the QP, one can obtain the following relation:

2^{(C-K2)}·2^{(QP}^{_{LSB}}^{/6)}=2^{C}·2^{(A-K1)}·2^{(QP}^{_{MSB}}^{/6)}

which in turn leads to the following relation:

QP_{LSB}=QP_{MSB}+6·(A+K2−K1)

If the number C of least significant bits are represented on K2 bits, with C<K2, and if these bits are placed as the least significant bits of the K2 bits (the empty most significant bits of the K2 bits being filed with value 0), the equation reads as follows:

QP_{LSB}=QP_{MSB}+6·C

Several solutions can be used to control the quantization parameter for the chroma components.

It is to be recalled that according to the HEVC standard, the parameter known as ‘QpBdOffsetC’ is not signalled within the bit stream but can be computed from the syntax element known as ‘bit_depth_chroma_minus8’ according to the following relation:

QpBdOffsetC=6*bit_depth_chroma_minus8

where ‘bit_depth_chroma_minus8’ is equal to the bit-depth of the chroma signal minus 8 (8 being the minimum allowed bit-depth in HEVC).

Therefore, according to a particular embodiment, the parameter ‘QpBdOffsetC’ is used to control the quantization parameter that is to be applied to the chroma components. QpBdOffsetC is enforced to a given value that depends on the number of MSBs, “A”. This value is advantageously set to 6·C (QpBdOffsetC=6·C) when the input samples have been split into a number A of most significant bits and a number C=(B−A) of least significant bits, with the C least significant bits being placed as least significant bits of the K2 bits. This value is advantageously set to 6·(A+K2−K1) (QpBdOffsetC=6·(A+K2−K1)) when the input samples have been split into a number A of most significant bits and a number C=(B−A) of least significant bits, with the A most significant bits being placed as most significant bits of the K1 bits and the C least significant bits being placed as most significant bits of the K2 bits.

Then, the quantization step for chroma QP_{C} is derived from the quantization step for luma QP_{Y} according to the following relation:

QP_{C}=QP_{Y}+QpBdOffsetC

According to the HEVC standard, the quantization parameter for chroma can be controlled by the syntax elements known as pps_xx_qp_offset and slice_xx_qp_offset where ‘xx’ is set to ‘cb’ or ‘cr’ depending on the component. Still according to the HEVC standard, the value of pps_xx_qp_offset+slice_xx_qp_offset shall belong to the range of −12 to +12, inclusive (i.e. [−12, 12]).

Therefore, according to a particular embodiment, the syntax elements ‘pps_xx_qp_offset’ and ‘slice_xx_qp_offset’ are used to control the quantization parameter to be applied to the chroma components and the HEVC limitations are relaxed in order that pps_xx_qp_offset+slice_xx_qp_offset can be outside the range of [−12, 12]. In a particular embodiment, the syntax elements ‘pps_xx_qp_offset’ and ‘slice_xx_qp_offset’ are such that pps_xx_qp_offset plus slice_xx_qp_offset is equal to 6·C (pps_xx_qp_offset+slice_xx_qp_offset=(6·C).).

Then, the quantization step for chroma QP_{C} is derived from the quantization step for luma QP_{Y} according to the following relation:

QP_{C}=QP_{Y}+pps_{—}xx_qp_offset+slice_{—}xx_qp_offset

Still in a particular embodiment, the MSBs are lossless-coded while the quantized coefficients corresponding to the LSBs part are not fully quantized, that is, while QS_{LSB}<2^{C}. Knowing QP for the LSBs QP_{LSB}, the QP for the MSBs can be derived as QP_{MSB} as (QP_{LSB}−6·C).

In a particular embodiment, the loop filter processes (deblocking filtering and Sample Adaptive Offset filtering) are disabled.

Still in a particular embodiment, the loop filter processes (deblocking filtering and Sample Adaptive Offset filtering) only apply on the “sub-samples 1” that typically correspond to the LSBs.

Still in a particular embodiment, the quantization parameter used for deblocking of “sub-samples 2” is set equal to the quantization parameter of “sub-samples 1” plus a pre-determined value. Such a pre-determined value can be set to (6·C).

Naturally, in order to satisfy local and specific requirements, a person skilled in the art may apply to the solution described above many modifications and alterations all of which, however, are included within the scope of protection of the invention as defined by the following claims. In particular, the invention could apply for a scalable codec.

APPENDIX
HEVC T_{32×32} matrix

| | | | | | | | | | | | | | | | | |
|---|---|---|---|---|---|---|---|---|---|---|---|---|---|---|---|---|
| 64 | 64 | 64 | 64 | 64 | 64 | 64 | 64 | 64 | 64 | 64 | 64 | 64 | 64 | 64 | 64 | 64 |
| 90 | 90 | 88 | 85 | 82 | 78 | 73 | 67 | 61 | 54 | 46 | 38 | 31 | 22 | 13 | 4 | −4 |
| 90 | 87 | 80 | 70 | 57 | 43 | 25 | 9 | −9 | −25 | −43 | −57 | −70 | −80 | −87 | −90 | −90 |
| 90 | 82 | 67 | 46 | 22 | −4 | −31 | −54 | −73 | −85 | −90 | −88 | −78 | −61 | −38 | −13 | 13 |
| 89 | 75 | 50 | 18 | −18 | −50 | −75 | −89 | −89 | −75 | −50 | −18 | 18 | 50 | 75 | 89 | 89 |
| 88 | 67 | 31 | −13 | −54 | −82 | −90 | −78 | −46 | −4 | 38 | 73 | 90 | 85 | 61 | 22 | −22 |
| 87 | 57 | 9 | −43 | −80 | −90 | −70 | −25 | 25 | 70 | 90 | 80 | 43 | −9 | −57 | −87 | −87 |
| 85 | 46 | −13 | −67 | −90 | −73 | −22 | 38 | 82 | 88 | 54 | −4 | −61 | −90 | −78 | −31 | 31 |
| 83 | 36 | −36 | −83 | −83 | −36 | 36 | 83 | 83 | 36 | −36 | −83 | −83 | −36 | 36 | 83 | 83 |
| 82 | 22 | −54 | −90 | −61 | 13 | 78 | 85 | 31 | −46 | −90 | −67 | 4 | 73 | 88 | 38 | −38 |
| 80 | 9 | −70 | −87 | −25 | 57 | 90 | 43 | −43 | −90 | −57 | 25 | 87 | 70 | −9 | −80 | −80 |
| 78 | −4 | −82 | −73 | 13 | 85 | 67 | −22 | −88 | −61 | 31 | 90 | 54 | −38 | −90 | −46 | 46 |
| 75 | −18 | −89 | −50 | 50 | 89 | 18 | −75 | −75 | 18 | 89 | 50 | −50 | −89 | −18 | 75 | 75 |
| 73 | −31 | −90 | −22 | 78 | 67 | −38 | −90 | −13 | 82 | 61 | −46 | −88 | −4 | 85 | 54 | −54 |
| 70 | −43 | −87 | 9 | 90 | 25 | −80 | −57 | 57 | 80 | −25 | −90 | −9 | 87 | 43 | −70 | −70 |
| 67 | −54 | −78 | 38 | 85 | −22 | −90 | 4 | 90 | 13 | −88 | −31 | 82 | 46 | −73 | −61 | 61 |
| 64 | −64 | −64 | 64 | 64 | −64 | −64 | 64 | 64 | −64 | −64 | 64 | 64 | −64 | −64 | 64 | 64 |
| 61 | −73 | −46 | 82 | 31 | −88 | −13 | 90 | −4 | −90 | 22 | 85 | −38 | −78 | 54 | 67 | −67 |
| 57 | −80 | −25 | 90 | −9 | −87 | 43 | 70 | −70 | −43 | 87 | 9 | −90 | 25 | 80 | −57 | −57 |
| 54 | −85 | −4 | 88 | −46 | −61 | 82 | 13 | −90 | 38 | 67 | −78 | −22 | 90 | −31 | −73 | 73 |
| 50 | −89 | 18 | 75 | −75 | −18 | 89 | −50 | −50 | 89 | −18 | −75 | 75 | 18 | −89 | 50 | 50 |
| 46 | −90 | 38 | 54 | −90 | 31 | 61 | −88 | 22 | 67 | −85 | 13 | 73 | −82 | 4 | 78 | −78 |
| 43 | −90 | 57 | 25 | −87 | 70 | 9 | −80 | 80 | −9 | −70 | 87 | −25 | −57 | 90 | −43 | −43 |
| 38 | −88 | 73 | −4 | −67 | 90 | −46 | −31 | 85 | −78 | 13 | 61 | −90 | 54 | 22 | −82 | 82 |
| 36 | −83 | 83 | −36 | −36 | 83 | −83 | 36 | 36 | −83 | 83 | −36 | −36 | 83 | −83 | 36 | 36 |
| 31 | −78 | 90 | −61 | 4 | 54 | −88 | 82 | −38 | −22 | 73 | −90 | 67 | −13 | −46 | 85 | −85 |
| 25 | −70 | 90 | −80 | 43 | 9 | −57 | 87 | −87 | 57 | −9 | −43 | 80 | −90 | 70 | −25 | −25 |
| 22 | −61 | 85 | −90 | 73 | −38 | −4 | 46 | −78 | 90 | −82 | 54 | −13 | −31 | 67 | −88 | 88 |
| 18 | −50 | 75 | −89 | 89 | −75 | 50 | −18 | −18 | 50 | −75 | 89 | −89 | 75 | −50 | 18 | 18 |
| 13 | −38 | 61 | −78 | 88 | −90 | 85 | −73 | 54 | −31 | 4 | 22 | −46 | 67 | −82 | 90 | −90 |
| 9 | −25 | 43 | −57 | 70 | −80 | 87 | −90 | 90 | −87 | 80 | −70 | 57 | −43 | 25 | −9 | −9 |
| 4 | −13 | 22 | −31 | 38 | −46 | 54 | −61 | 67 | −73 | 78 | −82 | 85 | −88 | 90 | −90 | 90 |

| | | | | | | | | | | | | | | |
|---|---|---|---|---|---|---|---|---|---|---|---|---|---|---|
| 64 | 64 | 64 | 64 | 64 | 64 | 64 | 64 | 64 | 64 | 64 | 64 | 64 | 64 | 64 |
| −13 | −22 | −31 | −38 | −46 | −54 | −61 | −67 | −73 | −78 | −82 | −85 | −88 | −90 | −90 |
| −87 | −80 | −70 | −57 | −43 | −25 | −9 | 9 | 25 | 43 | 57 | 70 | 80 | 87 | 90 |
| 38 | 61 | 78 | 88 | 90 | 85 | 73 | 54 | 31 | 4 | −22 | −46 | −67 | −82 | −90 |
| 75 | 50 | 18 | −18 | −50 | −75 | −89 | −89 | −75 | −50 | −18 | 18 | 50 | 75 | 89 |
| −61 | −85 | −90 | −73 | −38 | 4 | 46 | 78 | 90 | 82 | 54 | 13 | −31 | −67 | −88 |
| −57 | −9 | 43 | 80 | 90 | 70 | 25 | −25 | −70 | −90 | −80 | −43 | 9 | 57 | 87 |
| 78 | 90 | 61 | 4 | −54 | −88 | −82 | −38 | 22 | 73 | 90 | 67 | 13 | −46 | −85 |
| 36 | −36 | −83 | −83 | −36 | 36 | 83 | 83 | 36 | −36 | −83 | −83 | −36 | 36 | 83 |
| −88 | −73 | −4 | 67 | 90 | 46 | −31 | −85 | −78 | −13 | 61 | 90 | 54 | −22 | −82 |
| −9 | 70 | 87 | 25 | −57 | −90 | −43 | 43 | 90 | 57 | −25 | −87 | −70 | 9 | 80 |
| 90 | 38 | −54 | −90 | −31 | 61 | 88 | 22 | −67 | −85 | −13 | 73 | 82 | 4 | −78 |
| −18 | −89 | −50 | 50 | 89 | 18 | −75 | −75 | 18 | 89 | 50 | −50 | −89 | −18 | 75 |
| −85 | 4 | 88 | 46 | −61 | −82 | 13 | 90 | 38 | −67 | −78 | 22 | 90 | 31 | −73 |
| 43 | 87 | −9 | −90 | −25 | 80 | 57 | −57 | −80 | 25 | 90 | 9 | −87 | −43 | 70 |
| 73 | −46 | −82 | 31 | 88 | −13 | −90 | −4 | 90 | 22 | −85 | −38 | 78 | 54 | −67 |
| −64 | −64 | 64 | 64 | −64 | −64 | 64 | 64 | −64 | −64 | 64 | 64 | −64 | −64 | 64 |
| −54 | 78 | 38 | −85 | −22 | 90 | 4 | −90 | 13 | 88 | −31 | −82 | 46 | 73 | −61 |
| 80 | 25 | −90 | 9 | 87 | −43 | −70 | 70 | 43 | −87 | −9 | 90 | −25 | −80 | 57 |
| 31 | −90 | 22 | 78 | −67 | −38 | 90 | −13 | −82 | 61 | 46 | −88 | 4 | 85 | −54 |
| −89 | 18 | 75 | −75 | −18 | 89 | −50 | −50 | 89 | −18 | −75 | 75 | 18 | −89 | 50 |
| −4 | 82 | −73 | −13 | 85 | −67 | −22 | 88 | −61 | −31 | 90 | −54 | −38 | 90 | −46 |
| 90 | −57 | −25 | 87 | −70 | −9 | 80 | −80 | 9 | 70 | −87 | 25 | 57 | −90 | 43 |
| −22 | −54 | 90 | −61 | −13 | 78 | −85 | 31 | 46 | −90 | 67 | 4 | −73 | 88 | −38 |
| −83 | 83 | −36 | −36 | 83 | −83 | 36 | 36 | −83 | 83 | −36 | −36 | 83 | −83 | 36 |
| 46 | 13 | −67 | 90 | −73 | 22 | 38 | −82 | 88 | −54 | −4 | 61 | −90 | 78 | −31 |
| 70 | −90 | 80 | −43 | −9 | 57 | −87 | 87 | −57 | 9 | 43 | −80 | 90 | −70 | 25 |
| −67 | 31 | 13 | −54 | 82 | −90 | 78 | −46 | 4 | 38 | −73 | 90 | −85 | 61 | −22 |
| −50 | 75 | −89 | 89 | −75 | 50 | −18 | −18 | 50 | −75 | 89 | −89 | 75 | −50 | 18 |
| 82 | −67 | 46 | −22 | −4 | 31 | −54 | 73 | −85 | 90 | −88 | 78 | −61 | 38 | −13 |
| 25 | −43 | 57 | −70 | 80 | −87 | 90 | −90 | 87 | −80 | 70 | −57 | 43 | −25 | 9 |
| −90 | 88 | −85 | 82 | −78 | 73 | −67 | 61 | −54 | 46 | −38 | 31 | −22 | 13 | −4 |

Typical HEVC T_{4×4} matrix

| | | | |
|---|---|---|---|
| 29 | 55 | 74 | 84 |
| 74 | 74 | 0 | −74 |
| 84 | −29 | −74 | 55 |
| 55 | −84 | 74 | −29 |

1. A method of pre-encoding a picture to be encoded by a coding process comprising transformation and/or quantization, the picture comprising a plurality of samples of a predetermined bit-depth, the method comprising:
splitting each of the samples of the picture into at least two sub-samples, each of the at least two sub-samples being of a predetermined bit-depth, the bit-depth of the samples being higher than the bit-depth of each of the at least two sub-samples; and
storing the at least two sub-samples of each of the samples into at least two different components of at least one picture.

2. The method according to claim 1, wherein splitting each of the samples of the picture into at least two sub-samples comprises extracting a set of most significant bits from each of the samples and extracting a complementary set of least significant bits from each of the samples, each of the set of most significant bits and of the set of least significant bits being used to form one of the at least two sub-samples.

3. The method according to claim 2, wherein the bit-depth of a sub-sample comprising an extracted set of most significant bits is higher than or equal to the length of the extracted set.

4. The method according to claim 2, wherein the bit-depth of a sub-sample comprising an extracted set of least significant bits is higher than or equal to the length of the extracted set.

5. The method according to claim 2,
wherein the set of most significant bits is stored into a first component of a picture,
wherein the set of least significant bits is stored into a second component of the same picture, and
wherein the coding process comprises a quantization performed as a function of at least one quantization parameter, a first quantization parameter being applied to the first component and a second quantization parameter being applied to the second component, first quantization parameter being higher than the second quantization parameter.

6. The method according to claim 2,
wherein the set of most significant bits is stored into a first component of a picture,
wherein the set of least significant bits is stored into a second component of the same picture, and
wherein the coding process comprises a quantization performed as a function of at least one quantization parameter, the at least one quantization parameter being computed as a function of an item of data transmitted in a bit stream used to transmit the encoded picture.

7. The method according to claim 2,
wherein the set of most significant bits is stored into a first component of a picture,
wherein the set of least significant bits is stored into a second component of the same picture, and
wherein the coding process comprises a quantization, the quantization to be applied to the most significant bit set being performed as a function of the most significant bit set value.

8. A method of post-decoding a picture comprising a plurality of samples of a predetermined bit-depth, the picture being decoded by a decoding process comprising inverse transformation and/or inverse quantization, the decoding process providing a set of at least one picture comprising a plurality of components, at least two sub-samples of each of the samples being stored into different components of at least one picture, each of the at least two sub-samples being of a predetermined bit-depth, the bit-depth of the samples being higher than the bit-depth of each of the at least two sub-samples, the method comprising:
extracting from at least two different components of the at least one picture at least two sub-samples for each of the samples; and
merging the at least two extracted sub-samples, for each of the samples, to reconstruct the picture.

9. The method according to claim 8, wherein merging the at least two extracted sub-samples comprises obtaining a first set of bits from one of the at least two extracted sub-samples and obtaining a second set of bits from another one of the at least two extracted sub-samples, the first set of bits forming a set of most significant bits and the second set of bits forming a set of least significant bits, the sets of most significant bits and of least significant bits being used to form one sample.

10. The method according to claim 9, wherein the bit-depth of the sub-sample from which is obtained the first set of bits is higher than or equal to the length of the obtained set.

11. The method according to claim 9, wherein the bit-depth of the sub-sample from which is obtained the second set of bits is higher than or equal to the length of the obtained set.

12. The method according to claim 9,
wherein the first set of bits is stored into a first component of a picture, the second set of bits is stored into a second component of the same picture, and
wherein the decoding process comprises an inverse quantization performed as a function of at least one quantization parameter, an inverse quantization based on a first quantization parameter being applied to the first component and an inverse quantization based on a second quantization parameter being applied to the second component, the first quantization parameter being higher than the second quantization parameter.

13. The method according to claim 12, wherein the second quantization parameter is equal to the first quantization parameter plus six times the length of the second set of bits.

14. The method according to claim 9,
wherein the first set of bits is stored into a first component of a picture,
wherein the second set of bits is stored into a second component of the same picture, and
wherein the decoding process comprises an inverse quantization performed as a function of at least one quantization parameter, the at least one quantization parameter being computed as a function of an item of data received in a bit stream used to receive the picture to be decoded.

15. The method according to claim 9,
wherein the first set of bits is stored into a first component of a picture,
wherein the second set of bits is stored into a second component of the same picture, and
wherein the decoding process comprises an inverse quantization, the inverse quantization to be applied to the first set of bits being performed as a function of the value of the first set of bits.

16. The method according to claim 8, wherein loop filter processes of the decoding process are disabled.

17. The method according to claim 9, wherein the decoding process comprises loop filter processes that apply only to the first set of bits.

18. The method according to claim 9, wherein the decoding process comprises loop filter processes that apply to the second set of bits and to the first set of bits, a quantization parameter to be used for processing the second set of bits being set equal to a quantization parameter to be used for processing the first of bits set plus a predetermined value.

19. A computer-readable storage medium storing executable instructions of a computer program for implementing the method according to claim 8.

20. A device for post-decoding a picture comprising a plurality of samples of a predetermined bit-depth, the picture being decoded by a decoding process comprising inverse transformation and/or inverse quantization steps, the decoding process providing a set of at least one picture comprising a plurality of components, at least two sub-samples of each of the samples being stored into different components of at least one picture, each of the at least two sub-samples being of a predetermined bit-depth, the bit-depth of the samples being higher than the bit-depth of each of the at least two sub-samples, the device comprising at least one microprocessor configured for carrying out:
extracting from at least two different components of the at least one picture at least two sub-samples for each of the samples; and
merging the at least two extracted sub-samples, for each of the samples, to reconstruct the picture.
